(19) United States
(12) Patent Application Publication
(10) Pub. No.: US 2020/0234339 A1
(43) Pub. Date: Jul. 23, 2020

(54) SYSTEM AND METHOD FOR COORDINATING INFLUENCERS ON SOCIAL MEDIA NETWORKS

(71) Applicant: Visual Amplifiers Holdings Pty Ltd., Sydney (AU)

(72) Inventors: Benjamin Francis McGrath, Clontarf (AU); Aaron William Alan Brooks, Waverley (AU)

(21) Appl. No.: 16/737,513

(22) Filed: Jan. 8, 2020

(30) Foreign Application Priority Data
Jan. 18, 2019 (AU) 2019900155
Apr. 8, 2019 (AU) 2019901196

(51) Int. Cl. G06Q 30/02; G06Q 50/00

(52) U.S. Cl. CPC G06Q 30/0269; G06Q 50/01; G06Q 30/0214; G06Q 30/0242; G06Q 30/0261; G06Q 30/0276

(57) ABSTRACT

A method for use on a computing device for social media distribution involves registering a campaign with at least one data set related to at least one of: an age, a gender, a theme, a demographic, a jurisdiction, a location and a desired engagement rate. The campaign may be related to a social market media campaign with a predefined online handle or metadata set. From a user terminal, a database management system is accessed. The database management system is configured for compiling a set of online identities of social media users on social media websites matching one or data sets related to the campaign. At least one message including social media content associated with the online handle or metadata set is sent to a social media user. The social media user can accept to distribute social media with the online handle or metadata set from at least one private account.

### PRIORITY CLAIM

This application claims the benefit of the filing date of Australian Provisional Patent Application Serial No. AU 2019900155, filed Jan. 18, 2019, for “A SYSTEM AND METHOD FOR COORDINATING INFLUENCERS ON SOCIAL MEDIA NETWORKS,” and also claims the benefit of the filing date of Australian Provisional Patent Application Serial No. 2019901196, filed Apr. 8, 2019, for “AN IMPROVED SYSTEM AND METHOD FOR COORDINATING INFLUENCERS ON SOCIAL MEDIA NETWORKS,” the contents and disclosure of each of which is hereby incorporated herein in its entirety by this reference.

### TECHNICAL FIELD

The disclosure may relate to social media influencers, and in particular, to a computer system, software and/or method for recruiting and managing social media influencers in marketing campaigns or social media networks.

### BACKGROUND

In first world countries, a significant portion of the population are active users of social media and social media networks. The ever-increasing exposure of social networking activity supported by social networking entities, such as FACEBOOK® and TWITTER®, provides an open forum for sharing opinions and attitudes concerning a plethora of experiences and events. Many users frequently post their reviews and opinions of restaurants they dine at, products they purchase, professionals they engage and/or services they use. These reviews are typically positive or negative, and focus on personal experiences. Other third-party people then read this information and then may re-post or share the information to others in their respective groups and communities, reply with their comments, and/or submit their reaction in some other manner, e.g., indicating they endorse or condemn the post or content.

Social networking information is identified to be an effective marketing tool to a brand owner. It may be used to spread good and bad experiences of a particular brand to all walks of life without much scrutiny. In a sense, social media allows the users to providing customer survey and feedback that can define the brand image of the brand. For example, in 2009, when the song “United Breaks Guitar” shared by musician Dave Carroll went viral, it resulted in fluctuations in United Airlines' stock price, and costed stockholders millions in value. In 2017, a viral video of a passenger dragged out of the United Airline and a few comments of its CEO caused another significant fluctuation.

There were social media monitoring services that provided the function of scanning the volumes of content published by social networking entities, and could collect content relating to particular subjects. Some services provided keyword search capabilities and could collect social media containing one or more keywords. Other services might able to perform a semantic and/or a grammatical analysis of the collected content to filter out content that contains a keyword but was not related to a topic of interest.

While these sorts of information data sets may be useful to the brand owner, it could also be difficult to manage and interpret the information in any meaningful way. Currently, there is no integrated platform for any brand owners to select, engage and manage a set of social media influencers from a domain of online identities, or social media influencers assisting brand owners to advance their markets.

In this specification, an online identity can be a person, a company, a group of people sharing a single identity on a social media network. The online identity may also be a user who posts to social media for fun or for a career.

Previously, U.S. Pat. No. 9,262,722 disclosed a social networking application program for measuring the social networker's collective influence on the registered social networking websites. The program was adapted to automatically collecting empirical data regarding the social networker's use and activity level for the social networking websites. This included measuring frequency of an activity posting by the social networker to the social networking websites within a predetermined period. The program then determined number of responses to the activity posting and measured the length, quantitative and qualitative discussion emanating from the social networker's activity posting. The program further measured third party's use of the social networker's activity posting and assigned individual weighted scores for each quantitative and qualitative empirical data. With these data, the program generated an impact score by tabulating an aggregate of the individual weighted scores derived from the plurality of weighted scores; and posted the impact score on a social networking website viewable by the social networker and a community of friends. This program provided a method of comparing influencers on social media website. However, this specification does not disclose or teach that a marketer may be allowed to coordinate and collaborate with the identified influencers.

U.S. Patent Published Application No. 2009/0063254 discloses computer software for identifying one or more influencers. The computer software involved executing the following steps: (a) obtaining a list of customers; (b) determining a social network for each of customers; (c) selecting one or more attributes to be used for predicting a measure of influence for each of the customers; and (d) determining one or more influencers in the social network by using the one or more attributes. This computer software provided a method of identifying the influencers on social media website. However, this software does not allow a marketer to coordinate and collaborate with the identified influencers. There are also a number of other problems with this system that the present disclosure may alleviate.

Further, referring to U.S. Patent Published Application No. 2004/0167814 there is disclosed a method regarding influence network marketing. The goal of this method is to provide a framework for marketing a product to a plurality of consumers in a target online community. This method comprising the steps of: (a) determining an influence network for the consumers in the target community; (b) identifying opinion leaders from among the members in the influence network; (c) presenting the product to the opinion leaders; and (d) assisting with dispersion of evaluations of the products from opinion leaders to the members in the target community by using the influence network. This prior art merely disclosed a theory of marketing through influencers. However, this method does not allow a marketer to coordinate and collaborate with the identified influencers.

U.S. Patent Published Application No. 2012/0150631 disclosed a method in relation to key influencer-based social media marketing. This prior art document disclosed a method for engaging social network users that comprised the steps of: (a) determining characteristics of key influencers; (b) setting search parameters based upon the determined characteristics; (c) searching social media feeds for possible key influencers; and (d) targeting possible key influencers with comments. The method is adapted to searching for relevant keywords across social networks, blogs, forums, and the like; filtering conversations that contain relevant keywords to show only conversations near a business location; and responding to location-based conversations, driving potential customers to a call-to-landing page, whereby one has a one-on-one conversation at or about a specific geographic location with people having a conversation relevant to a particular business. This prior art merely disclosed a theory of marketing through influencers. However, this method also does not allow a marketer to coordinate and collaborate with the identified influencers.

### BRIEF SUMMARY

### Problems to be Solved

The present disclosure relates to a computer system or method for coordinating and collaborating remote online identities on social media networks.

It may be advantageous to provide for a system that connects Influencers with brands or sponsors more effectively.

It may be advantageous to provide for a system that can retain funds for a campaign and distribute agreed upon funds after a predetermined task has been completed.

It may be advantageous to provide for a system that can coordinate users of social media for marketing purposes.

It, therefore, may be an object of the present disclosure to provide a new and novel for computer system and method that provides a platform for coordination and collaboration with social media network influencers.

Other objects and advantages will become apparent when taken into consideration with the following specification and drawings.

It may be an object of the present disclosure to overcome or ameliorate at least one of the disadvantages of the prior art, or to provide a useful alternative.

In a first aspect of the present disclosure, there may be provided a method for use on a computing device connected to the Internet for social media distribution. The method comprising the steps of registering a campaign with at least one data set related to at least one of; an age, a gender, a sex, a theme, a demographic, a jurisdiction, a location and a desired engagement rate. The campaign may be related to a social media campaign with a predefined online handle or metadata set. From a user terminal connecting accessing a database management system for compiling a set of online identities of social media users on social media websites matching one or data sets related to the campaign. Sending at least one message including social media content associated with the online handle or metadata set to a social media user, and wherein the social media user may accept to distribute social media content with the online handle or metadata set from at least one private account.

Preferably, the step of compiling a set of online identities further comprises the steps of adding one or more online identities to the database management system. Preferably, the step of compiling a set of online identities further comprises filtering one or more online identities from the set. Preferably, the method further comprises the steps of displaying one or more statistical reports in accordance with the retrieved set of online identities, receiving input from a user terminal to adjust the statistical data on the statistical presentations; and adding or removing one or more online identities such that the set of online identities satisfies the adjusted statistical data. Preferably, the campaign is assigned a predetermined period of time for distribution of social media via at least one private account. Preferably, the method further comprises the step of sending an electronic invitation in one data format to each of the online identities in the set. Preferably, the social media user may be an Influencer with a minimum number of followers or average daily viewers. Preferably, the at least one message comprises a commission or offer for posting on social media via a private account. Preferably, the method comprises the steps of: compiling tracking report in according with the retrieved social media contents, wherein the tracking report comprising a list of each online identities and corresponding status in the marketing campaign. Preferably, the campaign creator may edit, delete or hide at least one social media distribution associated with the online handle or metadata set from at least one private account. Preferably, the method further comprises the steps of confirming a task completion such that a predetermined payment is made to a social media user account associated with the at least one private account; and updating the status of the campaign. Preferably, the method further comprises the step of making an electronic payment to the online identity based on the payment threshold status through a transaction server. Preferably, the method comprises the step of determining the number of social media users desirable for a campaign and the number of social media distributions with the online handle or metadata set. Preferably, the method further comprises the steps of automatically distributing, linking, or sharing one or more retrieved social media content on a webpage.

In another aspect, there may be provided a computer system, having a processing unit, data management system, and a communication module for connecting to the Internet. The computer system comprising a user interface adapted to receiving at least one data set from a first user of the system, the at least one dataset being related to a social media campaign. The at least one dataset comprises data related to at least one of; age, gender, theme, number of follows, engagement rate, related to a social market media campaign with a predefined online handle or a predefined metadata tag to the computer server. The the database management system may be adapted to allow the first user to search and compile data from the database management system related to the social media campaign, and the compiled data including a list of social media websites matching one or more dataset of the campaign. A data retriever adapted to retrieving social media content from one or more social media websites associated with the online handle and a user of the social media websites, and a processing unit being adapted to calculate the value of a social media user in relation to a campaign based on at least one of a follower count, a viewer count, a social media presence, a trending threshold, and a public opinion of the social media user.

Preferably, the processing unit may be adapted to determine a payment threshold for a predetermined number of social media posts by the social media user, and forwarding electronic payment instructions to a transaction server for transferring payment to the online identity. Preferably, the processing unit may automatically distribute, link, and/or share one or more social media posts on a remote web server. Preferably, the interface may be adapted to allow a social media user to distribute at least one social media post via the system that can be edited, hidden, or deleted by the first user of the system when the social media post includes the predefined online handle or the predefined metadata tag. Preferably, the communication module may be adapted to send at least one message to the social media user of the system including a request, a personal message, an update, a quote, or an order. Preferably, social media posts made via the system by the social media user may be remunerated at a predetermined rate in accordance with the campaign.

### BRIEF DESCRIPTION OF THE DRAWINGS

FIG. 1 is a schematic diagram of an electronic system of an embodiment of the present disclosure;

FIG. 2 is a schematic diagram of a system or method of an embodiment of the present disclosure;

FIG. 3 is a flow chart showing the login process of an embodiment of the present disclosure;

FIG. 4 is a flow chart showing the registration process of an embodiment of the present disclosure;

FIG. 5 is a flow chart showing the request of password process of an embodiment of the present disclosure;

FIG. 6 is a flow chart showing a process to create a marketing campaign on the system of an embodiment of the present disclosure;

FIG. 7 is a flow chart of managing a market campaign on the system of an embodiment of the present disclosure;

FIG. 8 is a flow chart of an embodiment of a Brand contacting an Influencer via the system;

FIG. 9 is a flow chart of an embodiment of an Influencer contacting a Brand via the system;

FIG. 10 is a flow chart of an embodiment of a campaign manager provided by the system;

FIGS. 11A to 11X illustrate embodiments of website interfaces of an embodiment of the system; and

FIGS. 12A to 12M illustrate mobile or handheld device interfaces of an embodiment of the system.

### DETAILED DESCRIPTION

Social media employed mobile and web-based technologies to create highly interactive platforms via which individuals and communities shared, co-created, discussed, and modified user-generated contents. Certain online identities, through activities on their blogs, tweets, viral channels, and the use of other social media, generated great interest towards their presences and formed a community around them. The individuals in the community tended to follow these identities and become influenced by the information posted by them. These online identities, are known as social media influencers (“influencer”), and represent a new type of independent third-party endorsers who have the ability to shape audience attitudes via social media channel.

In many cases, an online identity is an alias or handle of a person, a company, a group or other entity. It is not uncommon for a person to have more than one alias or handle, or different online identity.

As these influencers usually possess the power to affect purchase decisions of others (such as their followers) because of their real or perceived authority, knowledge, position, or relationship, vendors have started harnessing the influential power of these social media influencers (“SMI”) to promote their products in order to penetrate a target market in a more efficient and effective manner.

In an influencer marketing campaign, a vendor or brief supplier might provide a product to at least one influencer with or without cost, and expect the influencer to create social media content through their personal social channels, which may then be consumed by their followers or subscribers. Subsequently, social media content related to the product of the supplier could be spread to consumers who share similar interest as the influencers in order to generate a higher conversion rate (higher consumption of the product by consumers).

Different influencers may have different interests or specialties, such as make-up-specific channels or technology-specific channels. They may also represent different demographics—age group, gender, ethnicity, personal preference, education, social status, or any other desired demographic data. Previously, marketing professionals were required to spend extensive resources and time to identify a right channel and the right influencers for their products in a successful social media marketing campaign. Further, a vendor or its marketing representative may usually be able to identify one channel and engage only one influencer at a time. This method is extremely inefficient and ineffective for targeting influencers, and may not result in your products being reviewed or shared by the influencer.

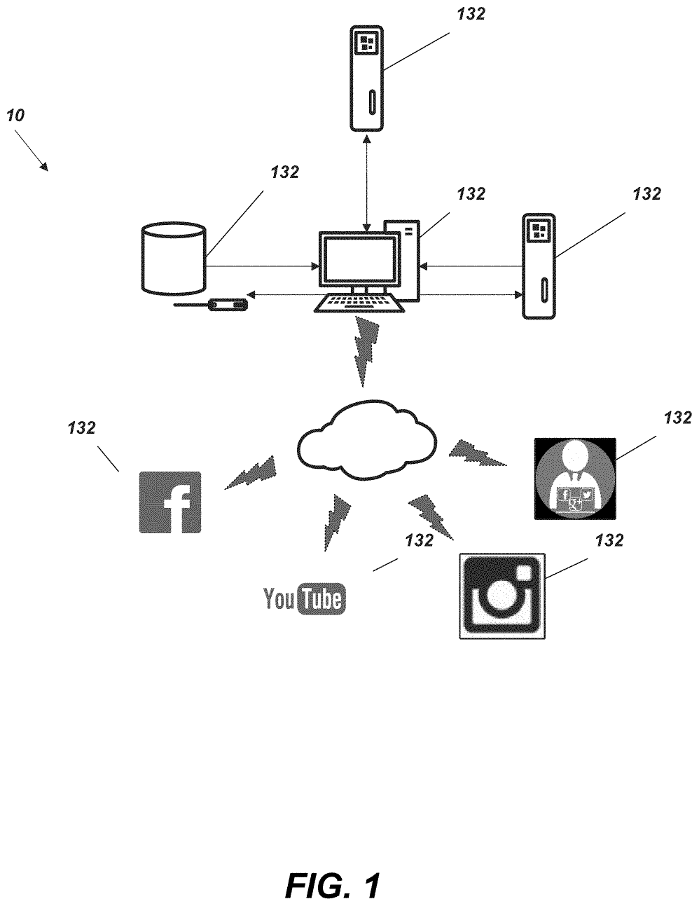

The present disclosure, therefore, provides a system 10 of an integrated platform for coordinating and collaborating with influencers in a marketing campaign, which comprises software adapted to run on a computer system as shown in FIG. 1 for coordinating and collaborating with social media influencers in a marketing campaign.

In one preferred embodiment of the present disclosure, there is provided a social media content processing method executed on a computing device or system connected to the Internet. The computing device may include a personal computer, a laptop, a notebook, a tablet, a tablet computer, a smart phone, a phone, an electronic device with a screen adapted to access the Internet, or any other predetermined device. The system provides a user interface on the computing device for receiving one or more criteria, which may comprise data (information) related to one or more of age, gender, theme, number of follows, engagement rate, related to a social market media campaign with a predefined online handle. With this information, the system connects to a database management system to compile a set of online identities on social media websites matching one or more criteria. The system then retrieves social media content from one or more social media web sites associated with the online handle and the online identities, and calculates a total amount of social media content associated with each of the online identities with the online handle. The system of the present disclosure may facilitate a marketing campaign creator to engage a team of unknown online identities or influencers to participate in a marketing campaign. The system provides an integrated platform to select and filter a large group of known or unknown online identities or influencers, automatically tracking social media content posted by this group of online identities or influencers, calculating and making remunerations or reward based on the automatically tracked records, and re-using and redistributing these social media contents over the Internet.

Optionally, the system may allow for Influencers to automatically be added to the database when a predetermined notoriety is achieved, a predetermined follower count is reached, a predetermined subscriber count is reached, when a particular sponsor engaged with an Influencer, or when an expected income level of an influencer is surpassed. For example, several of these analytics may be tracked by online platforms and data may be referenced from these sources. Optionally, the system is adapted to track expected revenue or income for an Influencer, and may also rank or track interactions with an Influencer on one or more of their social media platforms. If a ranking is assigned to an Influencer, the influencer ranking may then be used to separate Influencers into predetermined pools, which may then be available to a Brand of a particular reputation or size. For example, an Influencer with rank “A” may only wish to be associated with premium products or more well-known products to avoid reputation damage in the event that a product to be promoted is not safe or may have a negative consumer sentiment.

The system 10 comprising a computer server 11 associated with one or more database management system (DBMS) managing databases 12 for storing information of a group of social media influencers. The system 10 also is associated with one or more hyper-text transmission protocol servers 14 for receiving requests and forwarding hyper-text transmission protocol responses to the user of the system 10. In one embodiment, the requests and responses are exchanged in other types of formats such as extended message language format, or embedded in a JavaScript object notation files. The system 10 further associates with a message exchange server 16 to receive and forward messages to the users.

In one embodiment of the present disclosure, there is provided a system 10 that provides a single end-to-end electronic computing platform for recruiting, product distribution and making payment through the tracking of online performance score or payment threshold status based on the product penetration on the Internet. In one embodiment, the system 10 will keep track of all the social media contents posted by an online identity or Influencer, and release a payment based on the payment threshold status of the online identity or Influencer. For example, the system 10 may recruit INSTAGRAIVI® talent to produce high quality custom content designed to increase exposure and reach of the brand through mass aggregation of talent audiences. It will be appreciated that the system 10 is adapted to interact with Influencers from any predetermined social media platform or any other Influencer platform or online platform.

The present disclosure relates to a system 10 of an integrated platform for coordinating and collaborating with Influencers in a marketing campaign that is built around technology of searching and filtering to find the right Influencers for each marketing campaign via the platform.

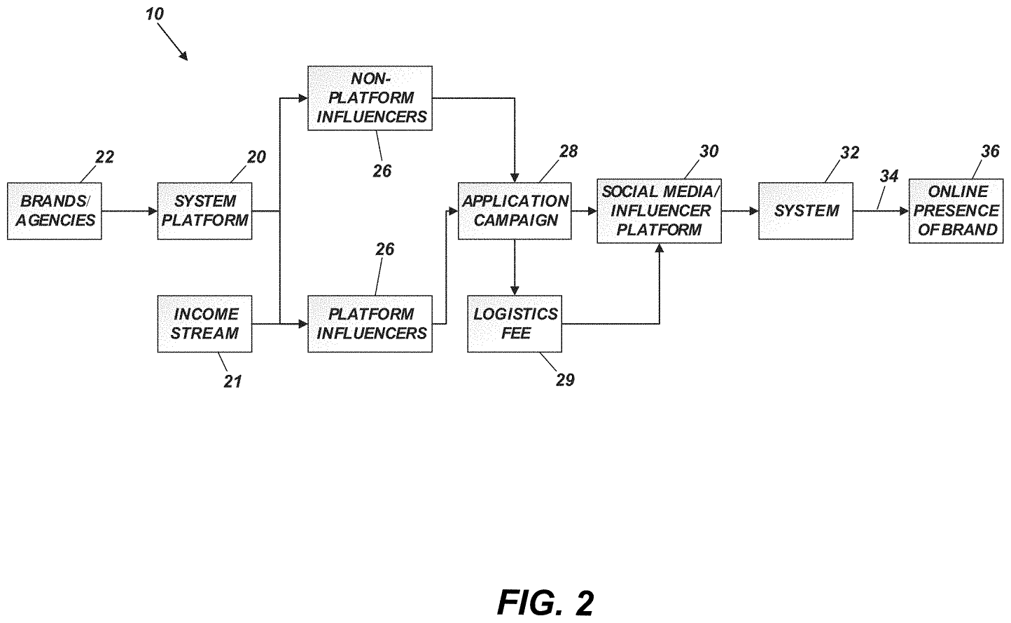

In one example as shown in FIG. 2, the system 10 is adapted to carry out a method 20 for matching Brand agencies with at least one Influencer. The system 10 or platform 20 allows a Brand or agency 22 to login to the platform 20 and manage a marketing campaign. Through the system 10 or platform 20, the Brand or agency 22 may select Influencers from a list of online identities from the group of register online identities, and unregistered online identities as show in step 26. The registered online identities are Influencers who have opened an account on the system 10 or platform 20. Influencers may be required to meet a minimum subscriber count, or Influencer threshold before being allow to sign up to the system. For example, certified blue checkmarks for twitter accounts may be a minimum threshold for being an Influencer on the platform 20. In another example, a minimum YouTube subscriber count of at least 100,000 followers may be required before being eligible for sign-up to the platform. It will also be appreciated that Influencers, which do not need a minimum threshold, may still be elected for use via the system. Users who do not meet a minimum threshold on the system may be up and coming Influencers, viral video creators or other predetermined persons that may be valuable to a marking campaign. The unregistered online identities are anyone who has not opened an account on the system 10 or platform 20, and these Influencers may be any person on a social media platform. It will be appreciated that minimum thresholds for Influencers may be specified on the platform and Influencers who do not meet the minimum thresholds may be omitted from the platform Influencer lists. Further, the system may be adapted to filter out recently controversial Influencers from lists that may damage a Brand associated with the Influencer. The influencer may have a risk rating or controversial rating that may be undesirable for more family friendly content and products, such as DISNEY®.

The system 10 or platform 20 then manages the campaign, sends out at least one message, such as an email or direct message, to the list of online identities (Influencers).

An income stream 21 from the platform may be provided to Influencers of the platform from a Brand or marketing agency 22. A brand or marketing agency 22 can initiate a campaign by creating a campaign project profile on system 10 or platform 20, which is associated with an income stream payment method for at least one Influencer.

The system 10 or the platform 20 is adapted to provide the facility to define the marketing tasks for the online identities or Influencers. For example, the Brand or agency 22 would like to promote its new product, and would send out the new product for the online identities or Influencers to review, and promote. The brand may use the facility provided by the system 10 or the platform 20 to create an invite and a briefing package. When an online identity or Influencer accepts the invitation, the system 10 or the platform 20 will notify the brand or agency 22 to send out the briefing package. Personal details for the Influencer may be provided to the Brand via the system 10 or the platform 20 such that the briefing package can be issued to an Influencer. The briefing package may require a postal address, phone number, or residential address of an Influencer and, therefore, the system will be adapted to only provide predetermined information based on the requirements of the briefing package. Alternatively, the briefing package can be mailed to a redistribution hub of the system 10 or the platform 20 and issued to the Influencer from the hub such that private information of Influencers is not released to unauthorized persons or accidentally released to Brands who do not require such personal information.

After at least one Influencer has been issued a request to join a campaign, the Brand or agency 22 may create the campaign by setting up the background material for the campaign. Background material for a campaign may include inputting the name, description, target audience characteristics, etc. of the marking campaign. It will be appreciated that the campaign may alternatively be made prior to selecting Influencers to allow the system to recommend to suggest more suitable Influencers for a particular campaign. Optionally, Influencers may apply for a premium subscription to the system 10 or platform 20, which highlights their profile(s) or provides a visual advantage over other Influencers of the system that may make an Influencer more appealing to a Brand. In step 24, based on the background information, the system 10 or platform 20 connects to the database 12 through the DBMS 11 to retrieve a list of online identities or Influencers, and allows the Brand owner or agency 22 to select a list of online identities from the group online identities. The brand owner or agency 22 may search and filter a set of online identities retrieved from the databases 12 and store it in the campaign project profile. In another embodiment, the brand owner or agency 22 may provide a set of online identities that are not stored in the databases 12. Optionally, the more campaigns an Influencer has completed may be associated with how strongly the Influencer is recommended to a Brand as the Influencer is likely to have already established a reputation for campaigns. Further, some Brands may wish to avoid particular Influencers if they have been associated with direct competitor campaigns, and the system may be adapted to filter out Influencers that have accepted campaigns from other predetermined Brands.

Once the Brand or agency 22 settles with a list of online identities, the system 10 or platform 20 will provide the function to manage the campaign, and send out emails and messages to the list of online identities as shown in step 26. The system 10 may further include a function for the online identities or Influencers to accept or reject an invitation. A rejection of an invitation may be automatic if the Brand is associated with predetermined products that an Influencer does not wish to be associated with. For example, an environmental focused Influencer may wish to reject any Brands or marketing campaigns associated with fossil fuels or mining. A rejection may also be provided when a predetermined Influencer campaign limit is reached, or an Influencer is unavailable for a campaign. Further, a rejection may also be issued after a predetermined period of non-response to an invitation. Some Influencers may have an auto-accept function for predetermined Brands and/or marketing campaigns associated with preferred products.

After the Influencer or Influencers accept a task related to a marketing campaign, the system 10 or platform 20 will notify the Brand or agency 22 through the management subsystem 28 of such acceptance. Through management subsystem 28, the Brand or agency 22 may review the list of online identities or Influencers who have accepted a task or marketing campaign offer. The Brand and/or Influencer may also have the option to prematurely terminate an agreement if there is a potential for negative reputation or another negative effect to befall the other party. If a Brand or Influencer terminates a marketing campaign early, there may be a level of damage involved and, therefore, a level of compensation may optionally be paid to the party who did not terminate the agreement. In one embodiment, the management subsystem 28 is installed with the facility to track the progress of each online identities or Influencer. For example, the management subsystem 28 is adapted to record whether the briefing package is sent and delivered. Optionally, a logistics fee 29 is paid by the Influencer or the Brand (preferably the Brand) to deliver the briefing package.

When the online identities or Influencer receives the briefing package, the Influencer should follow the directions given with the briefing package within the predetermined time limit for the campaign. Typically, the online identities or Influencers will try the product or use a particular service. The online identities and the Influencers will post comments, create blogs, images, etc., based on their experience with the product and share them on at least one social media website 30 such as YOUTUBE®, INSTAGRAM®, PINTEREST®, TUMBLR®, SNAPSHOT®, REDDIT®, FLICKR®, or any other social media or user influenced platform.

In one embodiment, the system 10 or platform 20 comprises a tracking interface 32. The tracking interface is adapted to track or follow the online identities posts on social media websites in accordance with the marketing campaign. Optionally, the system may have access to posts associated with the marketing campaign, and a Brand may have the option to restrict view, hide or delete a post made by an Influencer if they believe it may damage the Brand or there is public backlash. The Influencer may have an opportunity to appeal any restriction, hiding or deletion of a post by a Brand if they are providing a genuine review or have a suitable reason for the post to remain. By tracking and following the Influencer posts on social media websites, the system 10 or platform 20 can collect data of the progress of the campaign, and the performance of the online Influencer. The data will be stored in a database 12 of the system 10 for further analysis and may provide a rating to an Influencer regarding how well their posts receive positive Brand awareness or the amount of user interaction a post receives.

In one embodiment, the tracking interface 32 is in a form of at least one application programming interface for crawling a list of predefined social media websites, predetermined platforms or forums. In one embodiment, tracking interface 32 connects to and communicates with the application programming interface with the social media websites to collect data on the social media website (data scrapping). The tracking interface 32 is adapted to track the post contents, number of shares, number of endorsements, and number of viewers of a post by an Influencer. In another embodiment, the tracking interface 32 collects the raw data online to generate metrics such as the conversation rate, amplification rate, applause rate, and leads to potential or actual business.

The system 10 or platform 20 also provides the falcilities for generating and viewing reports of a campaign as in step 34. The reporting facilities allow the Brand or agency 22 to track the overall progress of the campaign. The reporting facilities also allow the Brand or agency 22 to track the progress of each individual Influencer. In one embodiment, the reporting facilities may associate a payment approval interface, so that the Brand or agency 22 may send instructions to payment institutes through the payment approval interface for distribution of payment to the online identities or Influencers. In one embodiment, the Brand or agency 22 may review a report of the campaign and the progress of the online identities or Influencers in which the report is generated by the system 10 or platform 20. Reports may be generated at any predetermined intervals and may indicate how successful a campaign is going based on similar or related campaigns. When an online identity or Influencer achieves its goal or key performance indicator, the Brand or agency 22 may use the interface provided by the system 10 or platform 20 to approve a distribution of payment. Even if a goal is not achieved by the campaign, the campaign may be adapted to end after a predetermined period of time or if all Influencers complete all of the agreed upon tasks. At the end or near to the end of a campaign, a Brand may have the option of extending a campaign and requesting further services from the Influencer.

In one embodiment, the interface for approving the distribution of payment is an action button for the Brand or agency 22 to click on. In another embodiment, the interface is an automated system, and automatically approve the distribution once the goal is achieved or PKI is fulfilled. In an embodiment, the interface is linked to a banking facility for directing the banking facility to deposit the promised amount to the online identities or Influencers. In another embodiment, the system 10 or platform 20 allows the online identity or Influencer to log into the system and review its performance report.

In one embodiment, the system 10 or platform 20 provides an interface to compile, update and manage an online presence as shown in step 36 using the posts or feeds provided by the online identities 22.

A front page of an interface can be displayed to a user when they log into the system 10 or platform 20. The front page of the interface may allow a user to navigate to a desired section of the system 10, such as an inbox, message board, job board, campaign request, campaign manager, or any other desired section of the system. When the program or application of an embodiment of the present disclosure is loaded it may present a predetermined user interface such as the front page interface.

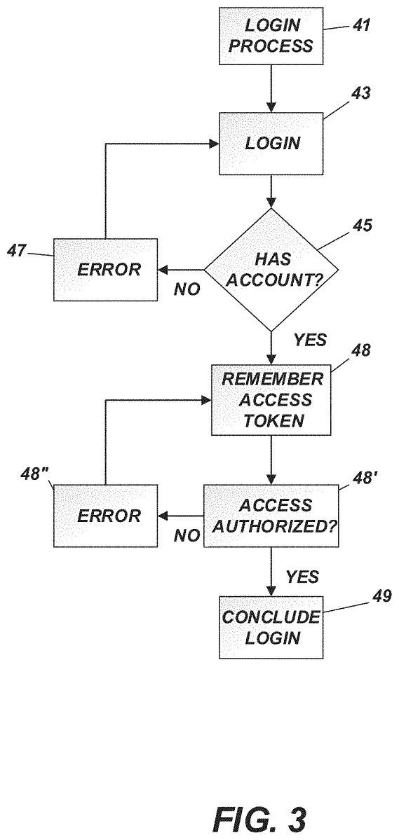

Referring to FIG. 3, there is provided a flow chart for a login process 40 of an embodiment of the present disclosure. The login process 40 begins in Step 41. In Step 43, the system 10 or platform 20 provides an interface for a user to login. The interface to login may be any predetermined or known login interface common in the art, and may require an authentication, captcha, verification or other means to determine whether a user is a human or not, which may assist with protecting user accounts from brute force attacks. In one embodiment, a user can be an administrator, a Brand, a campaign creator, an online identity, or an Influencer. The account may be associated with a user type, such as a Brand or Influencer, however the system may not require a user to login via a portal specific to the account type. The system 10 or 20 is adapted to load the correct profile and credentials when the user is logged into the system. In one embodiment, on the login interface provided in Step 43, the user is required to provide a user name and a password in order to login, which is common in the art. In Step 45, the system 10 or platform 20 checks whether the login information is correct. In the event that the information is not correct, an error message will be displayed as shown in Step 47 and the user may be redirected back towards step 43 and be prompted to login again, or reset a password. In the event that the login information is correct, an access token is created and stored in the system 10 or platform 20 in Step 48. The access token may be a stamp, log or record of the location of the user, time stamp, IP address of the login, terminal identification, and/or any other desired information. The system may determine at Step 48′ whether the user is authorized to login, for example, a code may be issued to a user to verify or authenticate a login. If the login is not verifies, an error message may be issued to the user at Step 48″. However, if the user does authenticate the login, the user can proceed to Step 49. In Step 49, the login process is concluded, and the user profile and credential are loaded to the system. In another embodiment, the user may login using Open Authorization (OAuth), which allows a user's account information to be used by third-party services, such as Facebook, without exposing the user's password. Other passwords associated with the system 10 or the platform 20 can be saved by a third party for automatic fulfilment and authentication.

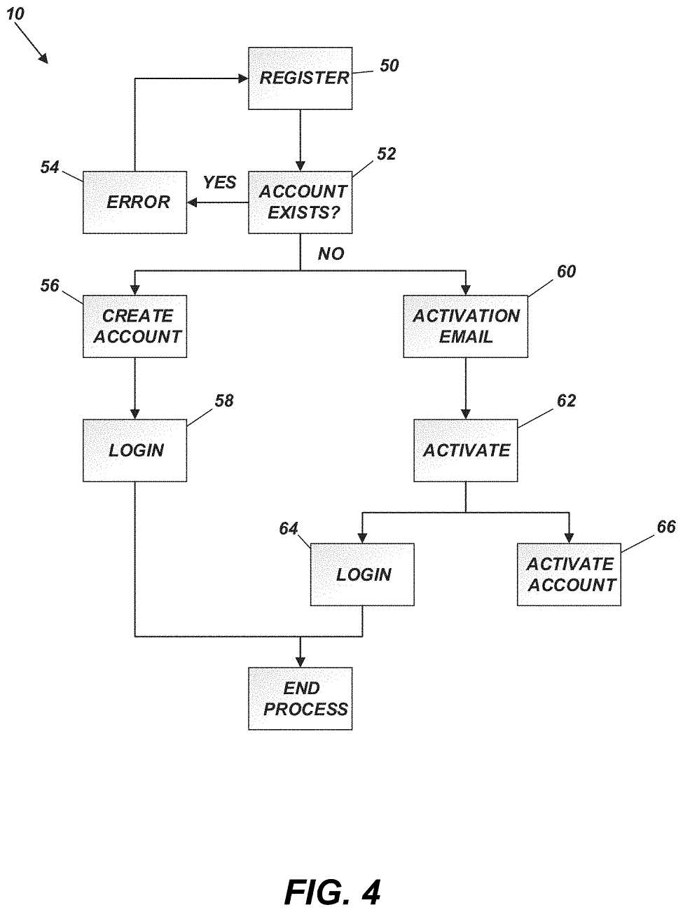

Referring to FIG. 4 is a flow chart showing a registration process using an interface of the system 10. The interface allows a user to enter user information such as the full name, company name, email address and password. In one embodiment, the password can be automatically generated by the system 10.

Referring to FIG. 4, the registration process 50 begins and the registration interface. The user enters the user information that will be used to generate a user profile and sends the information to the system 10 by interacting with an icon, such as an icon entitled “Create Account” or the like. When the system 10 receives the use information, it will check whether the account exists in the system as shown in Step 52. In this subroutine, the system 10 will connect to the user database and cross reference against the full name and company of the user. The system will display an error message if it finds out that an account already exists as shown in Step 54. An existing account may be an account that comprises an email address already in use or a username already in use.

In the event that the system 10 cannot find an existing account that matches with the desired user account, the system will then fork out two child processes. In one child process, the system will create an account as shown in Step 56. In this step 56, the system 10 will create a new record and user profile for the user in the database. The new record and/or user profile may be stored in the database of the system 10. The system 10 will then redirect the display to the login interface as shown in Step 58, but the user still cannot login their username and password until the account has been activated or verified. The create account Step 56 will allow

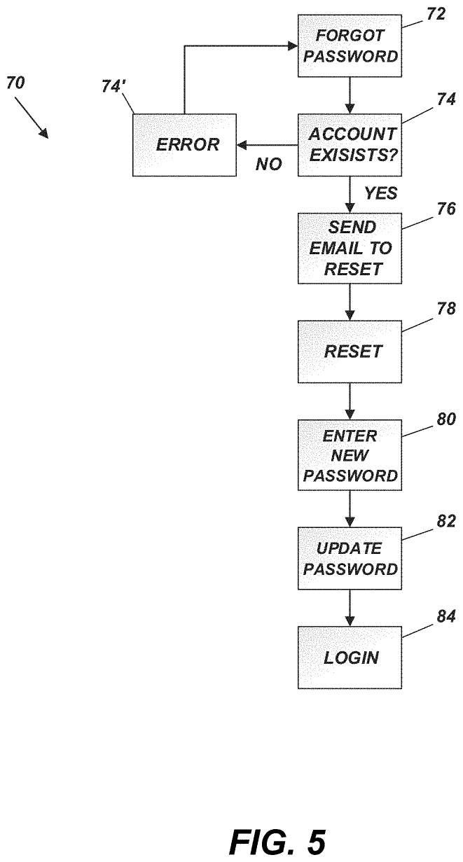

In the other child process, system 10 will generate and send an activation email to the email address entered by the user as in Step 60 of FIG. 5 on the registration interface. In the activation email, there is provided an activation link on which the user may click in order to activate the account. Other activation methods may also be used by the system, such as by linking a social media account, or by SMS verification methods.

When the user receives and selects the activation link as shown in step 62, the system will redirect the user to the login interface as shown in Step 64. The system 10 will also activate the account of the user as shown in Step 66. The system 10 will internally update the status of the user from “pending” to “activated.” Once the user account is activated, the user may then enter further information or data into the system 10.

FIG. 5 shows an embodiment of a process for handling a lost or forgotten password. On the login interface (not shown), under the input text box for entering the password, typically there is provided a link for directing a user to activate a process to recover lost password. When the user selects/interacts with the link, the system will initiate the process for handling lost password as shown in Step 70 of FIG. 5.

When a user selects a link for recovering a lost password, the system 10 will request some basic information from the user as shown in Step 72, such as User ID, login name, user name and date of birth or any other desired information relevant to a user profile of the system. A user profile may be a Brand profile or an Influencer profile. The system 10 then checks whether the user already has an account as shown in Step 74. If there is no match to a user in system 10, an error message will be displayed. If there is a match in the user database, the system 10 will retrieve the record of the user including the user email address. The system 10 then sends a reset password email to the user based on the retrieved email address to the user as shown in Step 76.

In the reset password email, there is embedded a link to reset the password of the user. When a user interacts with that link as shown in Step 78, the system 10 will direct the user to a password reset interface where the user can enter new password as shown in Step 78. In one preferred embodiment, the password reset interface, the system 10 is adapted to provide real-time checking to verify the strength of the password, such as with minimum 8 characters, not a dictionary word, no consecutive numbers, must have at least one upper case, lower case and special character. Optionally, the system may force a user to elect a password that meets a minimum threshold of security before allowing a user to reset or create a new password.

After the user enters a new password as shown in Step 80, the system 10 will update the new password and store it in the database as shown in Step 82. The system 10 then directs the user to the login interface as shown in Step 84 so that the user may now login to his or her account with the new password.

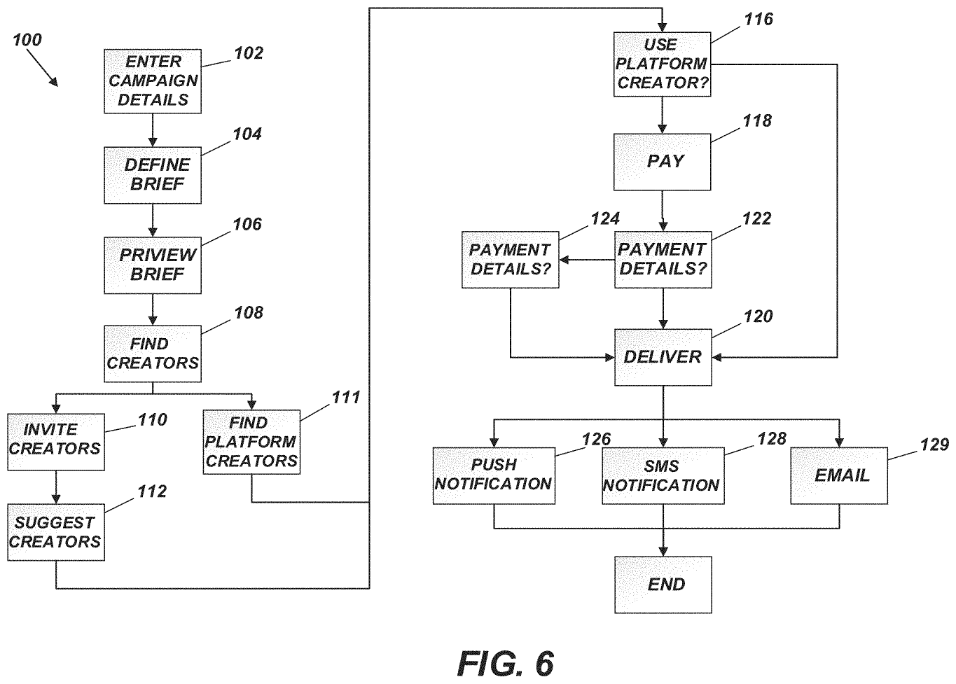

Reference is now made to FIG. 6 where a process 100 for creating a marketing campaign is shown. In one preferred embodiment, the process 100 started when a user elects to start a campaign, such as by selecting a “Get started” icon in a campaign interface. The system 10 then directs a user to the campaign overview interface, where the system displays all the marketing campaign profiles.

In a further embodiment, the campaign overview interface lists all the campaign rofiles along with images for identifying the campaign, a brief name of the campaign, the active dates of the campaign, and the status of the campaign. There is provided an icon or button for a user to create a new campaign. In one embodiment, the “create new campaign” icon or button is listed in front of all existing campaign profile. In another embodiment, the “create new campaign” icon or button is listed at the end of all existing campaign. In one embodiment, system 10 provides facilities for a user to filter, search and sort the campaign profiles.

If the Brand/Influencer selects the “create new campaign icon” or button, the system 10 will direct the user to the campaign input interface for carrying out Step 102 of the process 100 for entering the campaign details. In this embodiment of the process, the user may be a Brand. The campaign input interface allows the user to provide the name of the campaign, the name of the product, the submission date, and the social media meta tag or handle such as @mentions or #hashtags.

After the campaign details are entered into the system 10, it will direct the user to brief definition interface for carrying out Step 104 of the process 100 for defining a campaign brief, which includes a set of instructions for the online identities or Influencers to follow. An example of the brief definition interface. The campaign brief specifies what the online identities or Influencers should do or should not do during the campaign. Once the user has defined a campaign brief, the user may preview the campaign brief in Step 106.

After the user has defined the campaign brief as in Step 104 and previewed the campaign brief as in Step 106, the system 10 then directs the user to the find content creator interface to find creators/online identities/Influencers 108. The system 10 provides the option icon for the user to import the list of online identities to the system 10, or option icon for the user to choose from a list of online identities stored 111 in the system 10. Preferably, each entry from the list of online identities stored in the system 10 refers to an online identity who has been rated based on past records of participating previous social media campaigns. The record of each entry may contain information such as location, gender, age group, theme, narrative, format, style, relationship, social channels, or any other desired information. Optionally, other online identities or Influencers may be elected by the user manually, such as at Step 110.

When a user selects an option icon for importing a list of online identities (Influencers), the system 10 will direct the user to the manual data entry interface to carry out Step 110 for inviting the user's own online identities. Based on input Influencers, the system may also recommend similar Influencers 112. In one embodiment, the system 10 is adapted to receiving a comma-separated values (csv) formatted file containing the online identities handles, name, email, and mobile number. The system 10 is adapted to parse the csv file and generate a list of online identities. In another embodiment, the system 10 is adapted to allow the user to pick the online identities from the user previous list of online identities.

When the user is importing the list of online identities or creating a new list using previous lists of online identities, the system 10 is adapted to carry out Step 112 for suggesting the online identities stored in the system database. In Step 112, the system 10 analyses the list on the background to determine the common characteristics of the online identities selected by the user. The system 10 will determine a few online identities from the user selection list as model representatives of the online identities. The system 10 in real-time searches through the database for online identities who share similar characteristics of the model representatives. The system 10 then displays a message 144 to the user indicating that it can provide an extra number of the online identities for a cost, and provides a link or button 146 for the user to commit to engage those online identities. A user may decide not to engage the online identities provided by the system 10 and proceed to the next step for checking if any of the online identities retrieved from the system database is used in Step 116.

If the user decides to engage the online identities suggested by the system 10 the user can select the desired online identities then the system 10 will then direct the user to a find or search interface, such as a find content creators interface, to carry out Step 114 of Finding a list of online identities. The find content creators interface is adapted to allow the user to dynamically select online identities who possess certain characteristics, including: location, gender, age group, theme, narrative, format, style, relationship, social channels, or any other desired characteristics. The system 10 can generate demographic reports to show the demographic ratio of the selected online identities. In another embodiment, the system 10 allows the user to set the demographic ratio and search for a list of online identities for the closest fit to that demographic ratio. In one embodiment of this process, the user may first define the sample size and the demographic ratio as the input parameters. The system 10 will retrieve a list of Influencers or online identities that will fit one or more characteristics of the model representatives according to the sample size. The system may also be used to retrieve relevant content consumers or target group samples, which may be relevant to one or more characteristics of the model representatives according to the sample size. The system 10 will then replace one or more online representative on the list in order to fit closer to the demographic ratio.

In a further preferred embodiment, the find interface provides a link or button for the user to review individual online identity depending on the credential of the user. The credential of the user is given by the system 10 depending on a number of factors, such as the subscription level of the user. By reviewing, adding and removing individual online identities from the list, the user may fine tune the demographic ratio to suit the marketing campaign.

In yet another embodiment, after a user decides to engage the online identities provided by the system 10 and proceed to the next step for checking the amount of the online identities retrieved from the system database is used in Step 116.

In the event that the user decides not to engage any online identities provided by the system 10, satisfies a no payment or discount threshold, the system 10 will proceed to Step 120 to deliver the invitations to the list of online identities.

In the event the user engages online identities provided by system 10, it will calculate the cost and direct the user to a payment interface to carry out Step 118, which allows user to enter payment information, such as the name on a credit or debit card, the card number and expiry date.

After the user enters the payment information, system 10 will proceed to Step 122 to check the validity of the payment details. In the event that the payment details are incorrect, the system 10 will prompt the user to enter the payment details again as in Step 124. In the event that the payment details are correct and the payment is clear, the system 10 will proceed the next Step 120 to deliver the invitations to the list of online identities.

Once the system 10 receives the signal to deliver the invitations, the system will send out the invitations to the list of online identities through: (i) system notification for other users of the system in Step 126, (ii) Short Message Service (SMS) of mobile devices in Step 128, and (iii) Email in Step 129. An invitation may be sent through SMS in Step 128; or an invitation may be sent through email in Step 129.

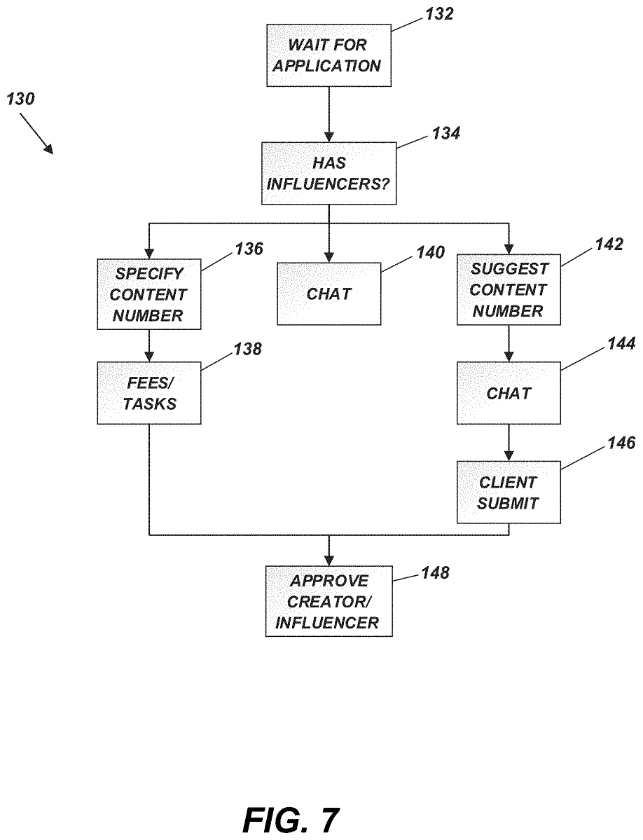

After the invitations are sent to the list of online identities, the system 10 will get ready to collect responses or applications from the online identities as shown in the process 130 of FIG. 7. The system 10 allows a campaign creator to wait for applications in Step 132. When an application arrived, the system 10 provides the function to check if the online identity and/or campaign creator is available in Step 134. Then the system 10 provides a platform for the online identities to communicate with the campaign creator. In one embodiment, the system 10 is adapted to allow the online identities to specify the number of content pieces in Step 136, and communicate in Step 138. Preferably, fees and tasks/actions may be negotiated by the Brand and the Influencer in Step 138. The system 10 also allows an online identity to carry out real-time voice, video or multimedia communications with the campaign creator via the system in Step 140, or carry out text messaging or other P2P communications. In another embodiment, the system 10 is adapted to allow a campaign creator to suggest the number of content pieces in Step 142, and negotiate with the online identities in Step 144 with regards to fees and/or tasks. The online identities then submit to accept the offer and the price in Step 146. In one embodiment, the system 10 provides an interface to specify the dialog scripts for approving and rejecting the submission of the online identities send to the campaign creator in Step 146.

After the campaign creator has confirmed with all the list of online identities, the number of content pieces, and the prices, the campaign creator may then approve the campaign in Step 148. Once the campaign is approved, the system 10 will direct the user to a campaign approval interface.

Typically, the campaign creator will send out any physical products and/or brief packages for the online identities to create social media contents. For example, the campaign creator may send out shoes or dresses to the online identities to take photographs and/or video, and upload the photographs to INSTAGRAM® and the video to YouTuBE® channel.

A campaign tracking interface of the system 10 of a preferred embodiment of the present disclosure to manage a campaign. On the left-hand section of the interface, there is provided a list of approved online identities or Influencers. In one embodiment, the system 10 provides another tracking interface, showing a list of online identities to which the campaign creator needs to send the products for creating social media contents.

The user may track whether the physical products and/or brief package has been sent out. In the middle section of the interface, the system 10 tracks the progress of the campaign, such as the number of social media content posted on the social media websites. In the right-hand section of the interface, the system 10 tracks the campaign in the complete stage, such as payment to the online identities or Influencer.

On the campaign tracking interface, the online identities or Influencers are presented with a profile photograph and a brief description of the online identity. When a user selects the profile photograph, the system 10 will direct the user to an Influencer Profile Interface.

On the Influencer profile interface of the system 10, the user may view the profile details of the online identity or Influencer, such as the real name, location, online handle, contact number, email address, postal address, system platform, social media channel, themes or any other predetermined profile details.

In one embodiment, the system 10 also allows the user to view the overview information of the online identity from the overview interface. The overview interface displays statistical information of the online identity, such as “reach monthly trend” and the “engagement monthly trend.” In one embodiment, the system 10 may also collect and generate other social media measurement metrics, such as volume in actions, share and view; reach; engagement; influence; share, traffic driven; click-through with bounce rate; conversation rate; amplification rate; applause rate; and leads. In another embodiment, the overview interface allows the user to compare the social media measurement metrics among different online identities or Influencers, with aggregate values of the entire campaign, or with historical values of previous campaign.

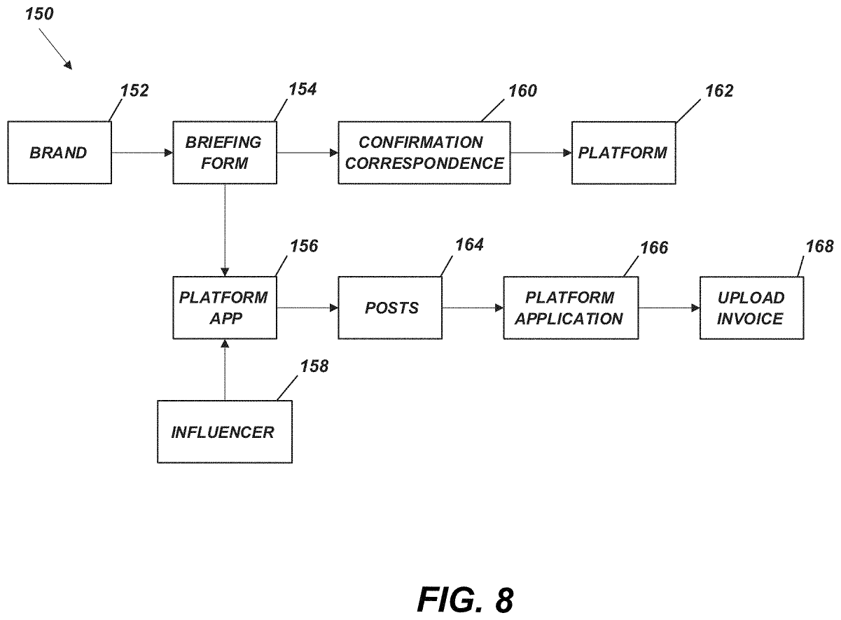

A flowchart 150 of an embodiment of a Brand contacting an Influencer is shown in FIG. 8. The Brand 152 may prepare a brief for a campaign 154, which can be used to contact and/or entice an Influencer for a campaign. The brief can include campaign specifics, tasks for an Influencer, goals or milestones. Each brief may be tailored for a specific Influencer such that custom briefs may be used for Influencers of a particular reputation, status or profile. Custom briefs may also be used to further entice an Influencer to join a campaign. A brief may include payment methods from a Brand and terms and conditions that must be accepted to issue a brief.

Once all relevant information has been uploaded to a brief 154, the brief can be issued to at least one Influencer 158 via the system or platform 156. The Influencer can be selected from a group of Influencers or may be manually entered by the Brand. For example, if an Influencer is not associated with the system 10 or the platform 20, the Brand may use the system 10 or platform 20 to issue the brief to a handle or social media platform. When the Influencer receives the brief a notification to the Brand can be issued 160. Optionally, a read receipt or read message may be issued to a Brand once the Influencer has viewed the brief from the Brand.

The Influencer can optionally edit the brief to include more specific details regarding prices for tasks and/or may edit terms of the brief If the brief is edited, the Brand may optionally review the brief and further amend the brief, negotiate with the Influencer or accept the amendments to the brief. Optionally, the brief issued to an Influencer is associated with a sign-up option for the system such that the Influencer is enticed to sign-up to the platform regardless of whether the brief is accepted or not.

If the brief is rejected, the Brand may be notified of the rejection. Optionally, a timer may be used once a brief has been opened by an Influencer for the Influencer to accept or edit a brief. If there is no acceptance or editing of a brief, the brief may be rejected at the expiry of the timer. A timer or predetermined limit on the brief may also be assigned by the Brand.

When a brief is accepted by an Influencer the Brand can be notified 160 and the campaign can progress or be updated with regards to the Influencer accepting the brief and the campaign on the platform can be updated 162. Each Influencer associated with a campaign may be issued the same brief, or may be issued custom briefs. Optionally, the system 10 can automatically generate a brief based on information and details uploaded by the Brand. After brief acceptance, the Influencer may be authorized to begin a campaign by posting to social media 164 (or posting to other predetermined mediums) or attending events or completing tasks as per the brief. The posts are preferably associated with the platform application 166. Packages may be sent out to an Influencer after acceptance of a brief, or may be sent to an Influencer for review before accepting a brief such that the Influencer can determine whether they wish to be associated with campaign.

Management of the campaign can be performed via the user interfaces of the system 10 or the platform 20. Fees and payments can be made via the user interface of the system, and payment options for the system 10 and/or the Influencer can be updated using the Brand manager interface provided by the system 10 or platform 20. The Brand manager interface may be associated with the Brand profile.

Content can be purchased or commissioned by the Brand using the system 10, or the platform 20, and Influencers can be managed for campaigns. When posts or tasks are completed the Influencer may upload an invoice or request payment 168.

The platform 20 or the system 10 may provide introductory media and documents to the Brand and/or the Influencer when a brief is issued and/or accepted such that both the Influencer and the Brand can more effectively communicate, understand their roles and their assigned tasks and how to manage the campaign via the platform 20 or the system 10.

While the system 10 or the platform 20 may be used to find further Influencers that are suitable for a campaign, further Influencers can be recommended by an existing Influencer (such as an Influencer associated with the campaign, or issued a brief for the campaign) and a commission may be provided to the existing Influencer if a further Influencer is elected for the campaign.

At stages throughout the campaign the Brand can generate at least one report or generate performance statistics in relation to a campaign.

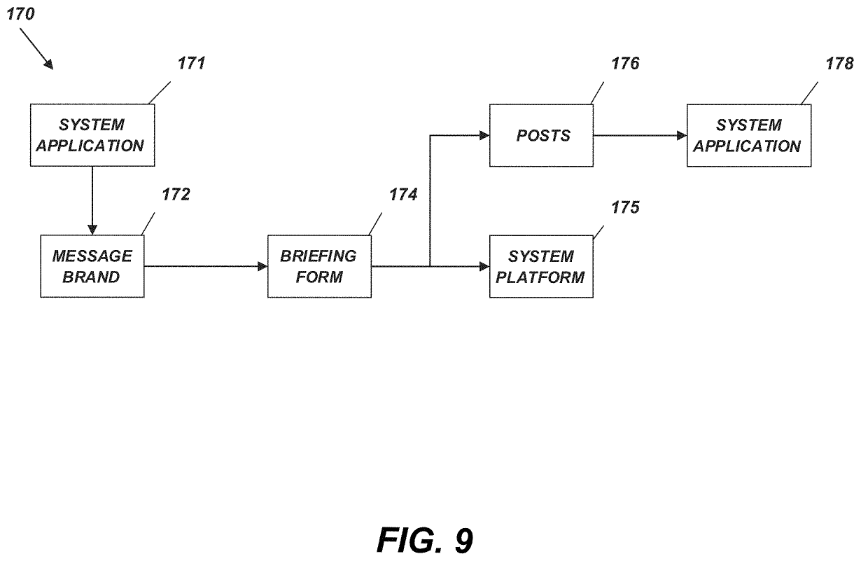

Shown in the embodiment of FIG. 9 is a flowchart in which an Influencer contacts a Brand 170. The Brand may have a brief, in which they provide to the system 10 or the platform 20 or, alternatively, the Influencer may have a product that they desirably would like to promote, and the Influencer may complete a brief 171 that may be used as a basis for a campaign by a Brand. A brief may be completed by using the system 10 or the platform 20. It will be appreciated that the Brand may not be active on the system 10 or the platform 20, and the brief may also include an invitation to join the system 10 or the platform 20. In this way, the Influencer may act as a Brand recruiter and may be entitled to an incentive or reward if the Brand elects to join the system 10 or platform 20 via the brief. An incentive may be offered to the Brand to sign up to the system 10 or platform 20 via the brief. For example, a discount or free campaign may be offered to a Brand and the system 10 or platform 20 may pay an Influencer at a desired or predetermined rate.

The Influencer completes a brief on the system 10 or platform 20, or uploads a brief to the system 10 or platform 20. The Influencer may then submit the brief (or message) to the Brand 172 for review 174. The review process may have an acceptance or rejection option, or may alternatively be ignored by a Brand. The system 10 or platform 20 may have a filter option for Brands such that Influencers of an undesirable size or reputation may not be able to contact certain Brands, in this way, it may be similar to a shadow-ban or other type of blocking means to prevent unwanted communications or spam.

In the Influencer can contact a Brand, the Influencer may message the Brand to review the brief. The message may be issued via the system 10 or the platform 20, which may be a direct message, a personal message, an email or any other desired form of communication allowed by the system 10 or the platform 20, or authorized by the Brand. The Influencer may then review the brief and determine whether the brief is satisfactory or unsatisfactory for a campaign. If the Brand does not respond to the brief within a predetermined period of time, or the Brand does not like the brief, the brief will be rejected and a message or notification may be issued to the Influencer, with or without a reason as to why the brief was rejected. Unsuccessful Influencers may be notified by the system 10 or platform 20 as to potential reasons why their brief was unsuccessful based on the brief issued by successful applicants (Influencers).

The briefing form may optionally be edited by the Brand during the review process and edits may be highlighted for an Influencer to review. Once a briefing form has been edited and submitted to the system 10 or the platform 20, the changes can be viewed by the Influencer. The Influencer may be notified of the updated briefing form by any desired messaging or notification means. A chat function may also be enabled for the Influencer and the Brand to negotiate and come to an agreement with respect to the briefing form (the brief).

If the Brand and the Influencer agree to the brief (briefing form) the Influencer can be notified once the system approves the brief 175, or acknowledges the brief. This may signify the beginning of a campaign or pre-campaign step.

After the approval of the brief the Brand may receive an introduction to the system 10, and/or the platform 20 if they are new to the system 10/platform 20. The Brand may view campaign reports and/or performance via the system 10 or the platform 20 at any desired time. In addition, the Brand may be allowed to purchase additional content for the campaign, or a future campaign that may be activated on the system when predetermined goals or milestones are met. In this way, the Brand can control expenditure for a campaign or delay expenditure until a predetermined time, goal or milestone. Goals and/or milestones may be authorized by a Brand and can elected to further a portion of a campaign, or may elect to terminate a potential portion of a campaign based on at least one of; reports from the system 10 or platform 20, customer feedback, expense or any other predetermined factor. The Brand may be able to view similar Influencers or Influencers that may be desirable for future campaigns based on the Brand profile and/or the existing campaign. The Brand may also have the option to sign up to the system for an ongoing subscription fee, or a fee that is paid at predetermined intervals, such as monthly.

When the brief is approved, the Influencer may be authorized to begin posting social media content 176 or other Influencer content based on the brief. All posts and Influencer content can also be mirrored or uploaded or associated with the system or the platform 178 such that the Brand can view logged progress via the system 10 or the platform 20 without being required to visit or view social media platforms. Further, the log may assist the system 10 or the platform 20 with directing future campaigns for the Brand or other Brands as certain actions or posts by Influencers may provide unusual positive feedback from consumers that may then be replicated in future campaigns for Brands.

The Influencer may upload content posted and invoices to a chat or log for the campaign, which may be authorized by the Brand, or questioned by the Brand. Once posts may been authorized or viewed, the Influencer may be paid for invoices uploaded and approved by the Brand and/or the system 10 or platform 20.

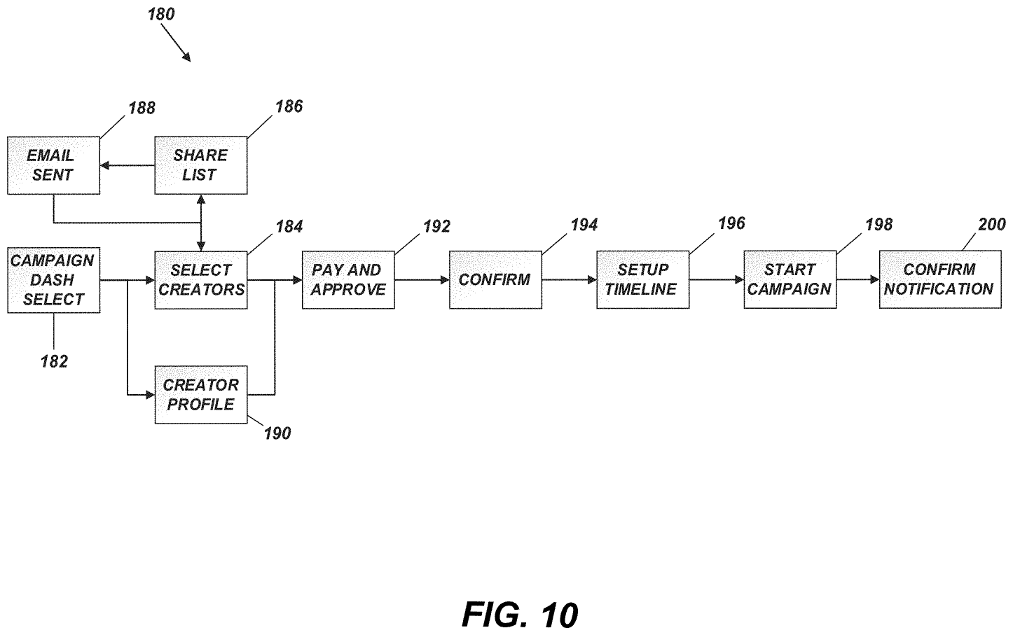

Referring to FIG. 10, there is shown a flow chart for generating a campaign 180. The campaign editor can be used to begin a social media campaign, or can be used to edit and/or access existing campaigns. A user of the system with sufficient authorization can access the campaign dashboard and select the desired campaign to interact with 182.

The campaign may have a list of Influencers (also referred to as creators or online identities) that are assigned to the campaign, or a list of pending Influencers that are pending to respond. A shared list of Influencers 186 may also be provided to a Brand or other Influencer. The campaign may also have a “wish list” type function that has a number of Influencers that may be desirable for a campaign, but have yet to be contacted, or a list of Influencers that have applied for a campaign may appear on the campaign creator list. In any case, the creators for a campaign may be selected from the list and individual profiles may be viewed 184. The Influencer profiles may have data related to their Influencer analytics, such as core viewer base, age, gender, location, or any other desired analytics that may or may not be relevant to a campaign. Optionally, an Influencer may be categorized into a predetermined group by the system such that the campaign may be more efficiently run by a Brand.

For example, an Influencer with a core viewer base of primarily males may be unsuitable for a campaign marketing feminine products and, therefore, the Influencer may be placed into a lower suitability tier. In contrast, an Influencer with a primarily female viewer base may be more suitable for a marking campaign for feminine products and may be placed in a more suitable group relative to the campaign. In this way, the more criteria the campaign specifies, the fewer Influencers may be presented as suitable for a campaign, but may also allow a Brand to more accurately target a market without a great deal of input into the system. Therefore, the system may be adapted to automatically suggest or recommend Influencers based on at least one set of parameters input into the system 10.

An Influencer profile may also have a function for interaction with the Influencer such that an agreement may be made before an offer is made, or an expression of interest can be generated before an offer is made. Optionally, the Influencer may be contacted after they have begun a campaign for a Brand such that progress reports or comments can be made. It will be appreciated that the Influencer may also contact the Brand via the platform 20 if there are any issues, or to contact the Brand in relation to the campaign.

Influencers for the list of Influencers may be associated with private accounts that can only be accessed if the Influencer contacts a Brand, or if another party (Brand, Influencer or Platform) provides the Influencer account or Influencer profile. When a campaign has access to at least one Influencer, the at least one Influencer may be selectively messaged 188 by the Brand with regards to the campaign. Messages may be emails, direct messages, notify notifications, alerts or any other desired method of communication allowed by the system. It may also be appreciated that a contact number of the Influencer may be on record and a message may be left. Optionally, the Influencer contact number may be accessible via contacting a directory of the system 10 or platform 20 and quoting or submitting an Influencer identification such that the system 10 or platform 20 then accesses a private influencer contact number and a message can be left with the Influencer or a conversation with the Influencer can be held. In this way, the system 10 or platform 20 can log and/or record conversations such that the system 10 or platform 20 has a record for the campaign. Records may also be used to charge a Brand and/or Influencer in relation to the campaign to ensure that Brands or Influencers are not circumventing the system 10 or platform 20. Optionally, a known Influencer profile may be targeted for a campaign 190.

Once the Influencers for a campaign are selected, the payment for the Influencers can be established 192. The payment may be a fixed fee, or may be a dynamically calculated fee. At least a percentage of the fee for an Influencer may be payable to the system 10 or platform 20, or alternatively a campaign may attract a flat fee or agreed upon fee (for the system 10 or platform 20) based on at least one of; a number of Influencers selected, a number of Influencers contacted, a length of the campaign, the type of campaign (for example, digital or in person), the Brand size, an Influencer rating, a number of Influencer tasks, a Brand rating or any other desired attribute. Once a final value for the campaign (or part thereof) has been generated, the payment can be made via the system or any other desired third party payment processing platform. Once payment has been verified 194, the system 10 or platform 20 may provide additional details with regards to Influencers and may also allow further communications between an Influencer and the Brand.

Further details regarding the campaign may also be issued to the Influencer regarding timelines 196 and the system 10 or platform 20 may be used to monitor and issue reminders to at least one of the Brand and/or the Influencer. The timelines and deadlines associated with a campaign may be viewed by the Influencer and the Brand via the system 10 or platform 20, with the Brand being able to see all relevant deadlines and relevant metrics for the campaign, while the Influencer may only be able to view their relevant deadlines and tasks upcoming. Once all campaign timelines, deadlines and payments have been made, the campaign may start, and a notification can be issued to at least one of the Influencers and the Brand indicating the beginning of the campaign 198.

The beginning of a campaign may be associated with a predetermined date that may also be associated with advertising materials for general distribution, or general display. For example, the beginning of a campaign may be associated with paid advertising on social media not using Influencers, billboards, paper advertising, events or other predetermined paid advertising. It will be appreciated that other paid advertising campaigns may have been running in advance of an Influencer being contracted to be involved with a campaign. As such, the predetermined date of the campaign via the system 10 or platform 20 may be associated with any desired date of the Brand. Optionally, the Influencer may be provided a window (predetermined period of time) in which to complete the campaign tasks assigned. Once a campaign starts, each of the Brand and the Influencer may be notified 200.

In one embodiment, the system 10 or the platform 20 may act as an escrow account in which funds for a campaign are held while the campaign is active, and when the completion of a task is completed the Influencer may be paid, or if the Influencer does not complete the tasks the Brand may be provided with a refund due to non-completion. If a task is not completed by and Influencer, the Influencer may receive a strike, warning, suspension, expulsion or other punishment for non-completion if there is no reason provided for the non-completion.

In another embodiment, the system 10 may project the expected performance of a campaign by interpolating the historical and current social media measurements from the campaign proposed or campaign currently in progress. The Brand may use this projection facility to simulate the performance of different groups of online identities or Influencers when filtering and choosing the group of online identities or Influencers to work on the campaign. For example, a campaign for targeting a specific age group may have Influencers that have had recent positive campaigns may be relevant to a proposed campaign. Further, historical measurements may be relative to a specific time of year, a specific type of campaign, a specific campaign strategy or any other predetermined factor.

The system 10 or the platform 20 may also provide a chatting facility for a user to communicate with an online identity or Influencer. The chatting facility allows users to communicate with the online identity across multiple platforms, such as mobile and tablet. Common chatting interfaces may be used as part of the system, but may also allow for the communication of a brief or a portion of a brief. Logs of chats may be recorded with a predetermined campaign, and/or may be stored by the system 10 or platform 20 such that adequate fees can be charged to a Brand of the system or an Influencer of the system.

In one of the preferred embodiment, the Influencer Profile Interface of system 10 allows the user to view, edit, change and delete the attributes of an online identity. On the Influencer Profile Interface, the user may also track the social media contents that are posted by the online identity or Influencer for the campaign. The Profile Interface may also allow for editing and mass posting to any predetermined social media to save the time of the Influencer and manage multiple posts at the same time. A metadata tag may be assigned to all posts coming from the system 10 or platform 20 and the system or platform 20 can track all associated posts. A metadata tag may be invisible to a post viewer, but may be associated with at least a portion of a post that may be viewable by the system 10 or the platform 20. Having metadata tags may allow Influencers to temporarily post and manage campaign content. Metadata tags may also be associated with hyperlinks that can redirect a viewer interacting with a post to a desired location. Metadata tags or other handles may be generated by the Brand and automatically associated with a post by the system 10 or platform 20 when an Influencer posts for a campaign.

While an Influencer may have multiple campaigns active at once to maximize income, an Influencer may select a single campaign to be active at a time when posting such that accidental posts to other campaigns are not made. Further, the Influencer may be prompted to confirm the campaign that they are posting for at least once to ensure that posts are made with correct handles or metadata. If a post is accidentally made for an incorrect campaign, the system 10 or platform 20 may allow mass-editing of posts to rectify the error. In one example, if a Brand notices that posts have been made for a campaign that are not relevant, the Brand may elect to remove any handles or metadata from a post the Brand is associated with, or in certain situations delete or hide a campaign post. This may allow for faster management and/or damage control of a campaign. Optionally, posts may be automatically deleted or hidden by the system after a predetermined amount of views or interactions. There are a number of reasons as to why posts may wish to be deleted after a predetermined number of views or interactions, such as market testing or campaign testing that can be beneficial for a Brand or an Influencer.

Further, the system 10 and platform 20 can be used to track and monitor user interactions with individual posts from Influencers. Based on at least one of a view count, a view count dependent on time, viewer interaction, a promotional code used by a viewer, or any other feature of a post, the system may better select future Influencers that are more engaging with an audience that may also reduce the costs of a campaign in the future. Reducing costs of a campaign and making a more targeted and streamline campaign may also increase the market presence of a Brand and may also improve the overall public opinion of a Brand.

All content posted using the system 10 or platform 20 may be tracked by the system 10 or the platform 20. Other media posted by an Influencer not via the system may be associated by the Influencer manually with the system 10 or platform 20. All posts may be added to a campaign log or ledger such that campaigns can be effectively tracked. Optionally, the system 10 may also trawl or search through recent posts of Influencers (or other social media users) for relevant metadata, handles, hashtags or other identifiers that may be relevant to the campaign. If there are negative connotations with a handle or campaign the campaign may issue an alert to the Brand for rectification of the campaign or just a notification of public repentance.

In one embodiment, the system 10 may send out a particular campaign handle for the online identity. When the online identity posts a piece of social media content, the online identity has to tag that piece of content with the campaign handle (which may also include metadata). The system 10 automatically tracks the online identity's social media page and searches for any contents that are tagged with the campaign handle. The system 10 then links to the piece of contents by “like,” “follow” and “share,” and reposts it under the Posts section of the Influencer Profile Interface.

In one preferred embodiment, system 10 provides a General Report Interface for a user to monitor the progress of the social media campaign. The General Report Interface may be used to show a number of performance indicators of the campaign, such as the average engagement rate, CPE Benchmark, number of posts, number of creators, etc. Other performance indicates and statistical data may be shown in this General Report Interface as well. In another embodiment, the General Report Interface allows the user to customize the report. The General Reporting Interface may also display new social media contents recently posted for the campaign.

With the social media contents, the system 10 allows the user to share, or reuse them on different media such as Instagram, mobile app, web page banners, or even poster on advertising display. In another embodiment, the system 10 may automatically distribute, link, or share one or more retrieved social media posts/content on a webpage.

In a preferred embodiment of the present disclosure, system 10 allows an online identity or Influencer to set up a profile using Profile Setup Interface. For example, the Profile Setup Interface allows the online identity to store the name, photograph, age, gender, and social media handle. Then the online identity may input the shipping address. The online identity may also select the themes that they are interested in when using the system 10 or the platform 20.

Reference now is made to the process for an online identity or Influencer using the system 10 to accept and take part in a campaign. Once the campaign creator has created a campaign and selected a list of online identities to participate in a campaign, the system 10 will distribute invitations to the online identities or Influencers. An invitation to participate a campaign in the form of a SMS message received by an online identity. Similarly, an invitation to participate a campaign in the form of an email message received by an online identity. Other means for communicating an invitation may be employed by the system 10 or the platform 20 that may be decided upon by the Brand. Optionally, an Influencer may not be commissioned by a Brand and the system 10 or platform 20 may be used by a Brand to ship packages to Influencers in the hopes that they will review the products sent to them without further remuneration other than the package of goods. It will be appreciated that the function of the system in this case is to ensure that the Influencer receives a package. The system 10 may be used as a reshipping or distribution hub for Brands such that the Influencer details remain confidential from a Brand to ensure client (Influencer) confidentiality of information.

The system 10 provides an Opt-In Interface for the online identity to review the brief. For example, the Opt-In Interface displays the name of the campaign, the product for creating the social media contents, the reward, and the campaign period, etc. On the Opt-In Interface, the online identity may accept the campaign task by clicking the relevant icon, or decline the take by clicking the relevant icon. Other icons may be used for the Opt-In Interface and allow for other functions to be selected, which may indicate interest in the future or may indicate that they are currently busy and will return and be available for a campaign at a predetermined time.

Once the online identity accepts the campaign task, the campaign creator can forward the brief package to the online identity or Influencer. Sometimes, the brief package allows to the online identity to acquire a new product to create the social media contents. In many case, these new products may be exclusive to the online identity. In one embodiment, the system 10 provides an Ordering Interface for the online identity to order the new product. An interface for online identity may select a particular product to create social media contents. An interface for the online identity to specify the particulars of the product, such as size, color, style, or any other predetermined particular. In one example, an AU/UK size of a piece of garment ranging 6-12 (or U.S. size 2 to 8) can be specified in the Ordering Interface for purchasing clothing.

In one embodiment, the system 10 provides Communication Interface for the online identity to communicate with campaign creator. In one preferred embodiment of the present disclosure, the Communication Interface works on multiple platform, such as email, SMS, mobile app, etc. The system 10 is adapted to detect the platform it is running on and choose the applicable presentation to display the message. For example, the system 10 may detect a mobile app is running and display the communication under the mobile app interface.

In another embodiment, the system 10 provides a Quote Preview Interface for the online identity to preview the quote and forward the quote to the campaign creator for approval. In the Quote Preview Interface, there is provided the issued date of the quote, the issuer of the quote—i.e., the real name of the online identity, the campaign creator, the description of the task, the mandatory rules, and the quote amount. When the campaign creator receives the quote, the campaign creator may accept or decline the quote.

Once the campaign creator accepted the quote, the online identity may then proceed to create and generate social media content on different social media websites including FACEBOOK®, FLICKR®, LINKEDIN®, YOUTUBE®, VENMO®, INSTAGRAM®, PINTEREST®, REDDIT®, Blog, TWITTER®, TWITCH®, TUMBLR®, WHATSAPP®, WECHAT®, and SNAPCHAT®, or any other social media website or social media platform, or social media publisher. It will be appreciated that throughout this specification any reference to an “online identity” can refer also be used to refer to an “Influencer.”

With the social media contents, the system 10 allows the user to share, or reuse them on different media such as Instagram, mobile app, web page banners, or even poster on advertising display.

In another embodiment, the online identities or Influencers can use the reporting function of the system 10 to monitor their performance, KPI, and the money earned from posting social media contents.

In one embodiment, a campaign may have data associated with it in relation to a desired demographic that may be dynamically changed during the course of the campaign if an unknown or unexpected demographic also shows interest in a campaign. For example, a campaign for MY LITTLE PONY® with a demographic for young girls in the 4 to 10 year old group may also be unexpectedly desirable for teenagers or young adolescents of the opposite sex. As such, marketing materials or Influencers associated with a campaign may change or be added to also include campaign materials for the new demographics.

Further, desired geographical regions or locations may be smaller targets for a campaign, which may be desirable for political campaigns. As such, Influencers may be selected from a predetermined jurisdiction or location, and the follower count or daily viewers may be less relevant when targeting smaller locations or jurisdictions.

In yet a further embodiment, any social media posts from an Influencer may be manually checked by a Brand, or may be checked for compliance by the system 10 or the platform 20. For example, if a post is to be made that includes explicit content or language, the campaign criteria may be referenced to check to see whether such content is allowable for a Brand. For example, DISNEY® may not allow explicit language or explicit content and, therefore, any post made with such content may be prevented from being posted, or may be hidden, deleted or edited to remove any such content.

Other filter systems may be used by the system 10 or the platform 20 to ensure compliance with a campaign, or compliance with morals or standards of a Brand such that a Brand is not accidentally damaged during a campaign. If content is marked as inappropriate, the Influencer may be notified of such inappropriate content and may be invited to rectify the post or be advised that the post may be limited in viewership or censored.

In yet another embodiment, Influencers may be provided with points or other progress indicators when partaking in campaigns to incentivize further posting or partaking in further campaigns. Influencer ratings may be linked to a number of posts made, or a number of campaigns participated in. Optionally, Influencers may have the option to post further content to social media in relation to a campaign without payment, but may receive a further boost to an Influencer rating or receive a benefit decided by the system or the Brand. In this way, campaigns can be gamified to encourage posting, which can assist a Brand with reducing the overall marketing costs associated with a campaign.

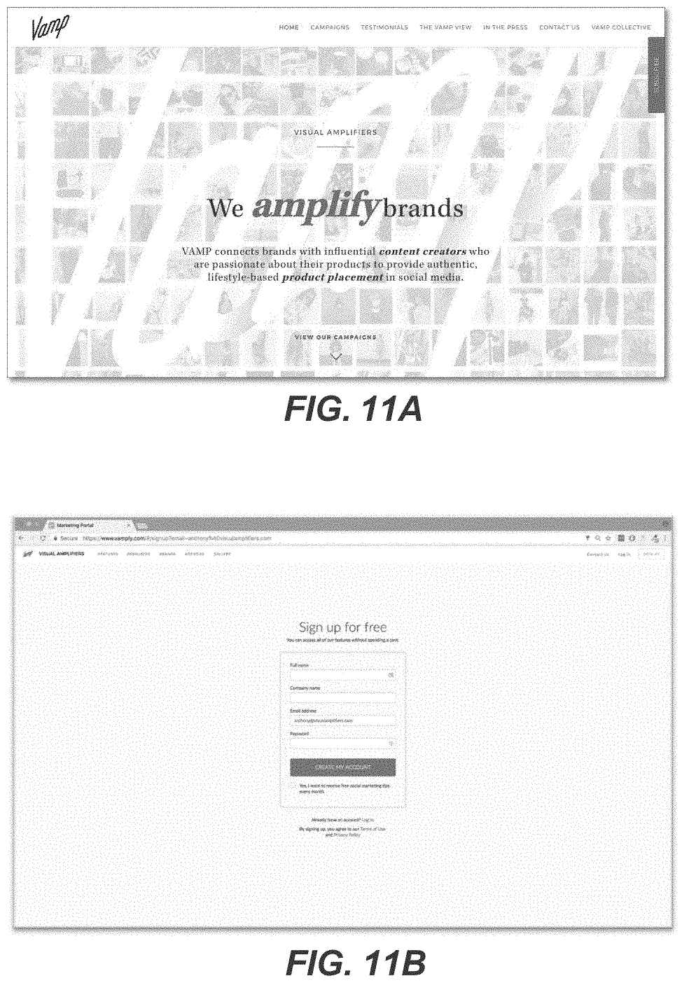

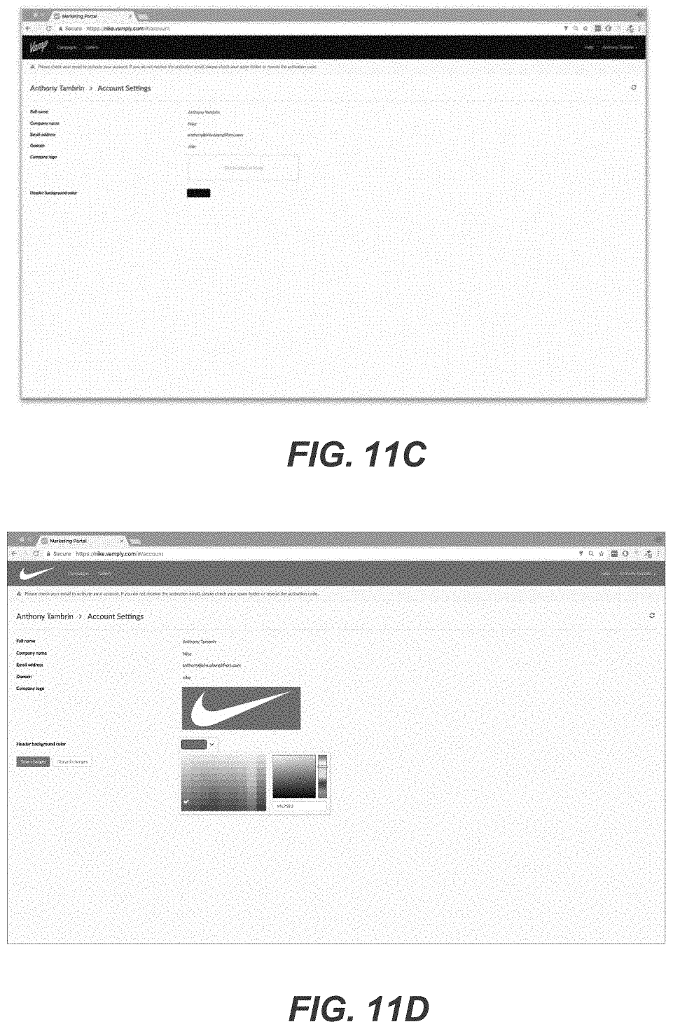

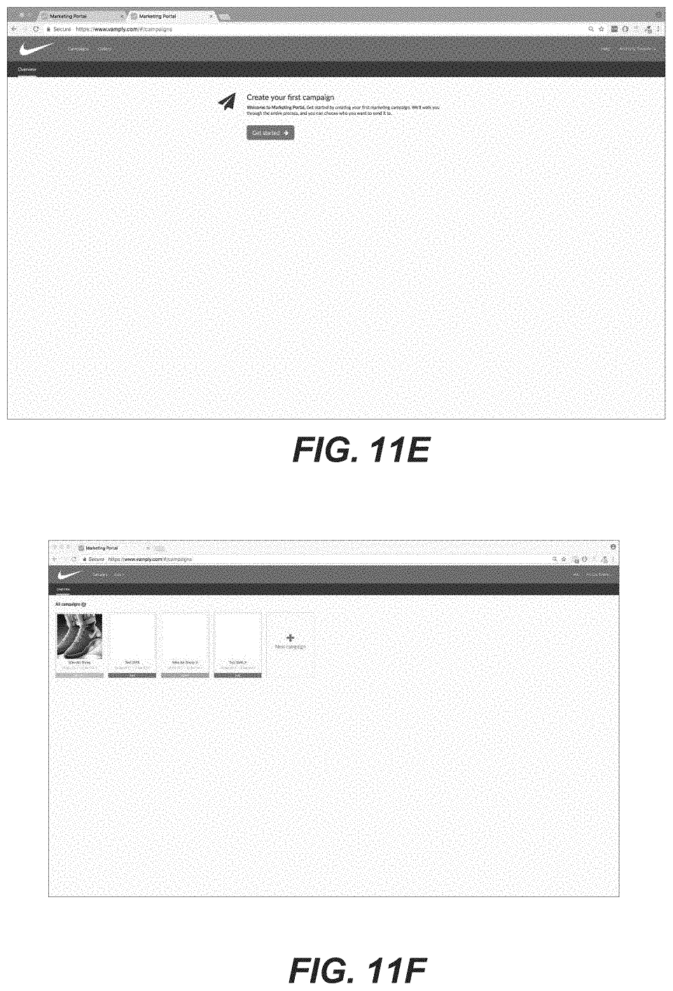

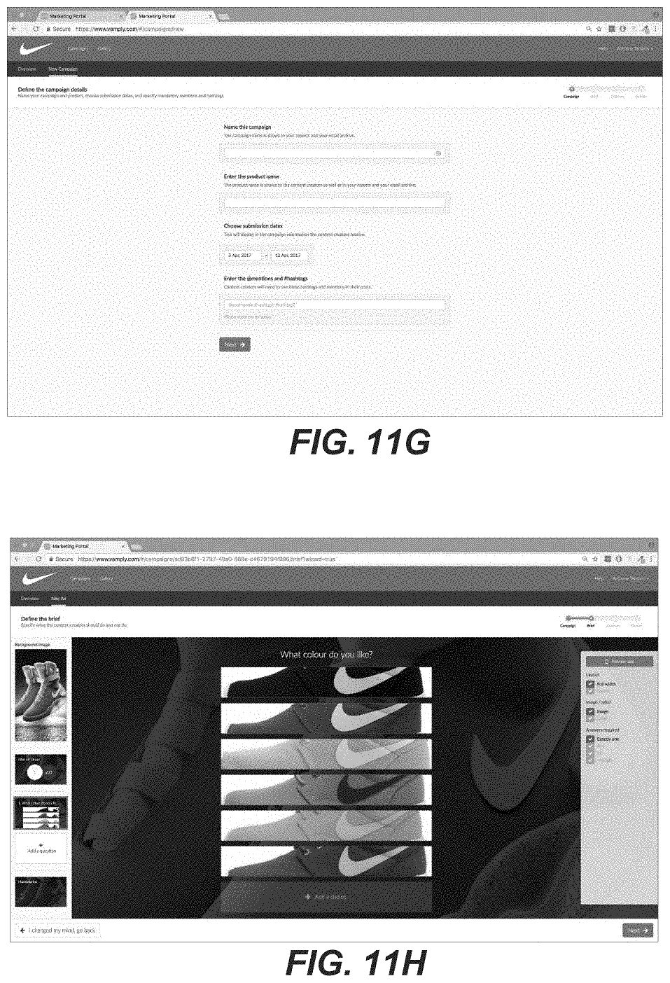

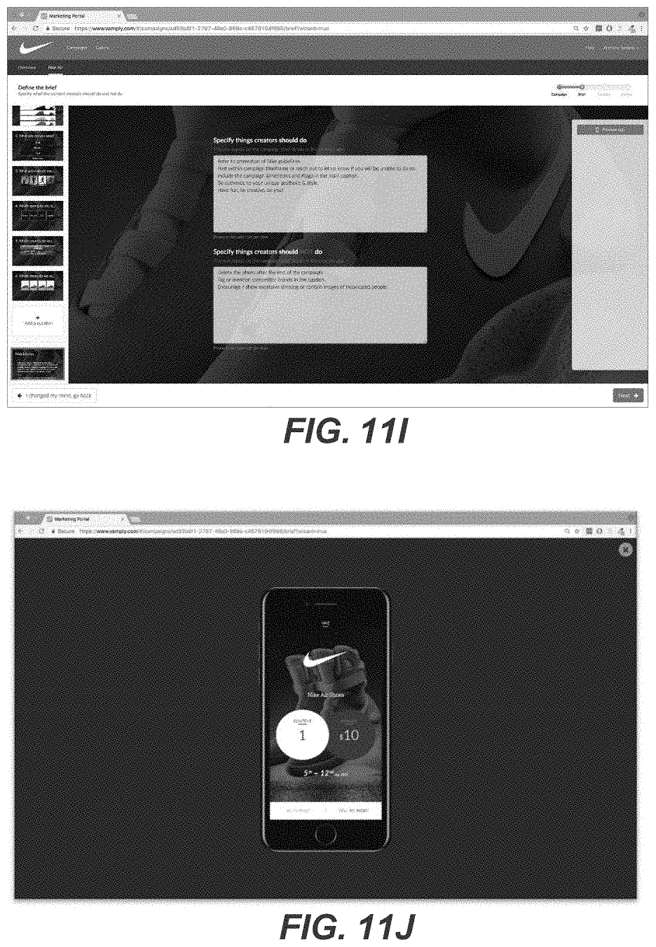

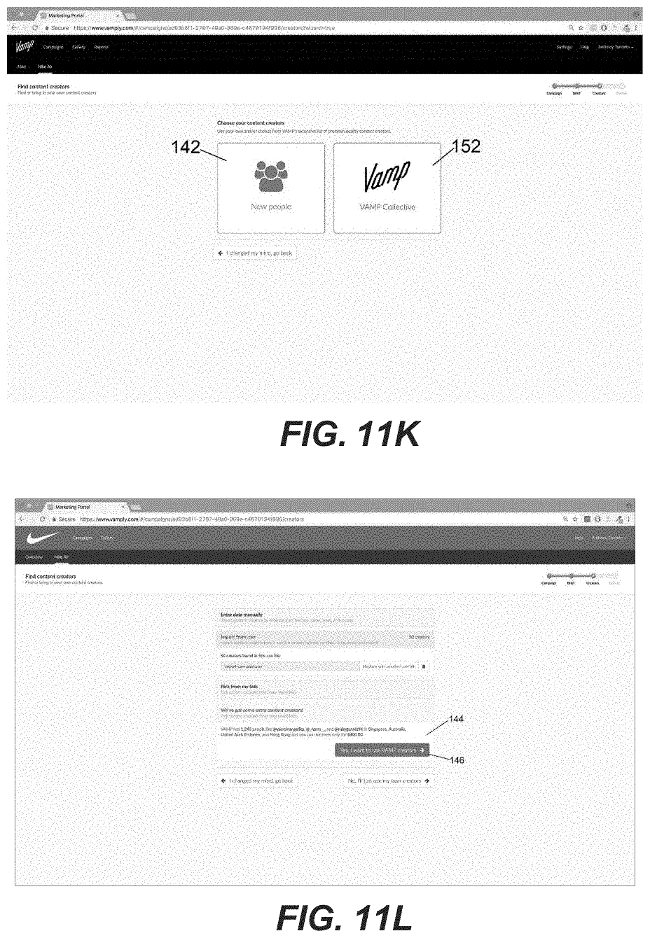

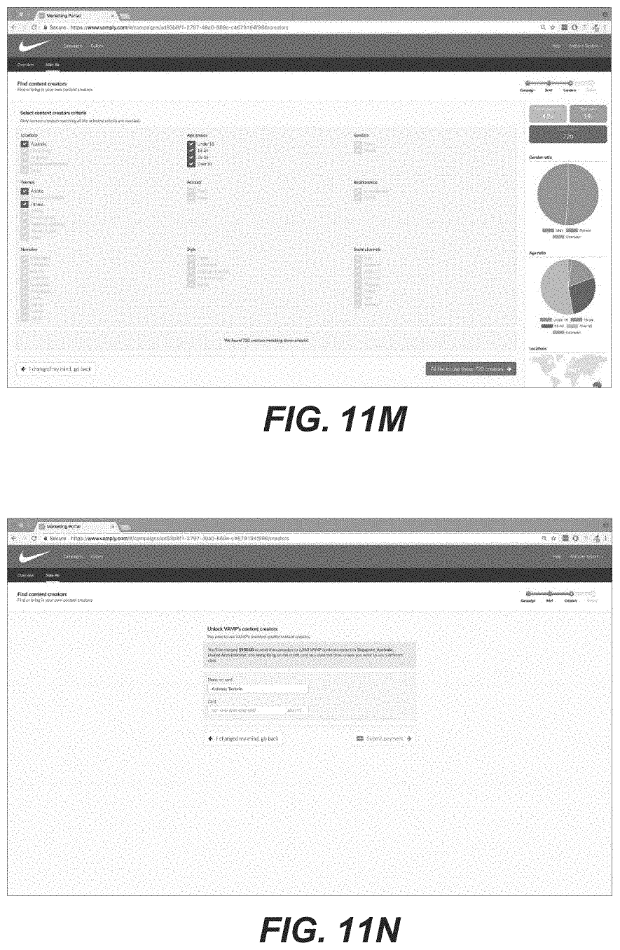

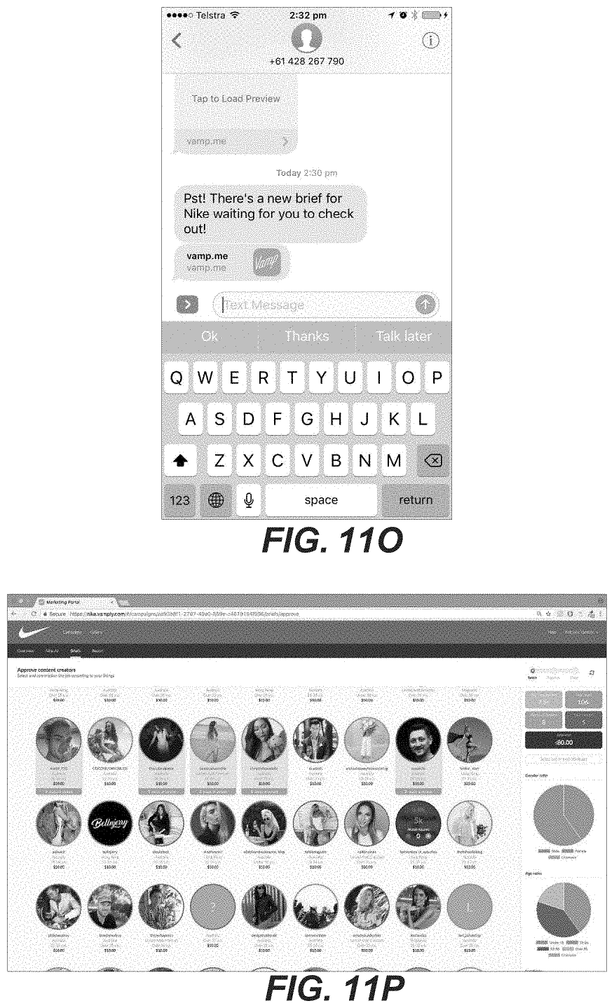

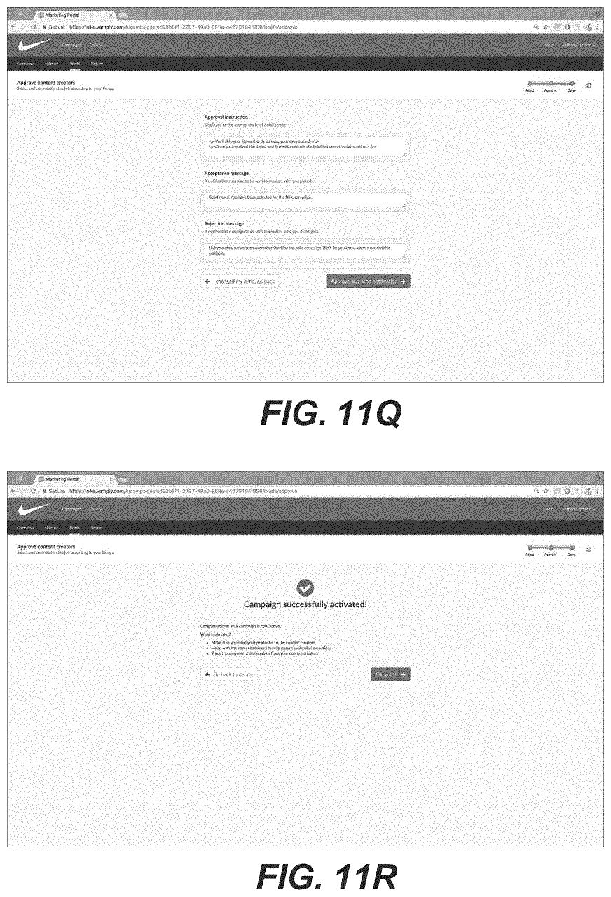

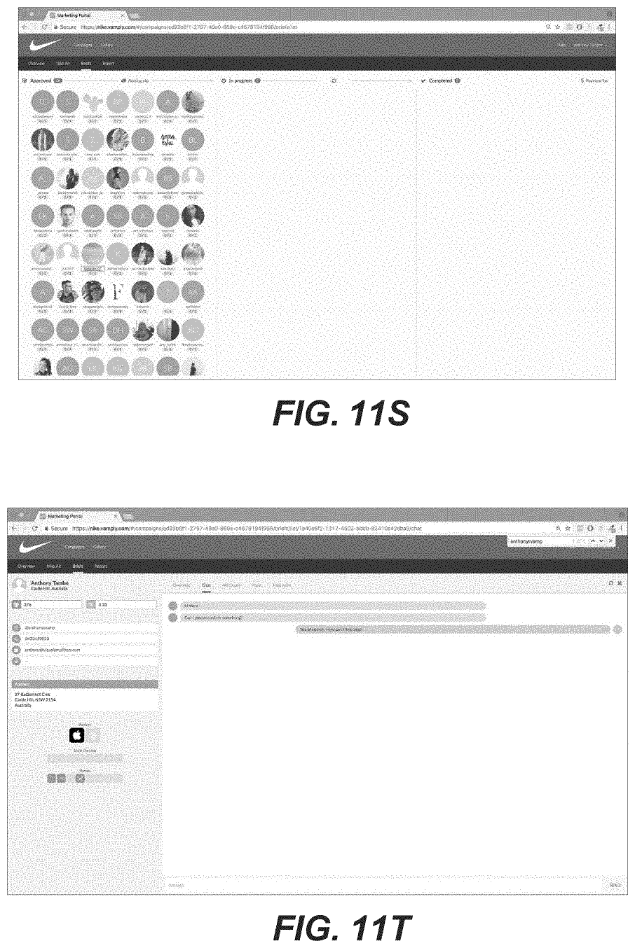

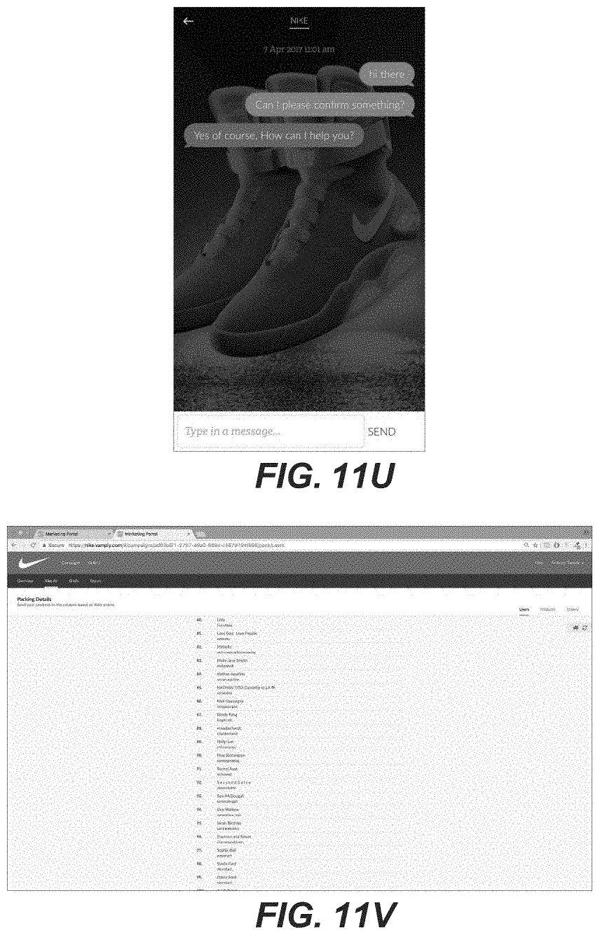

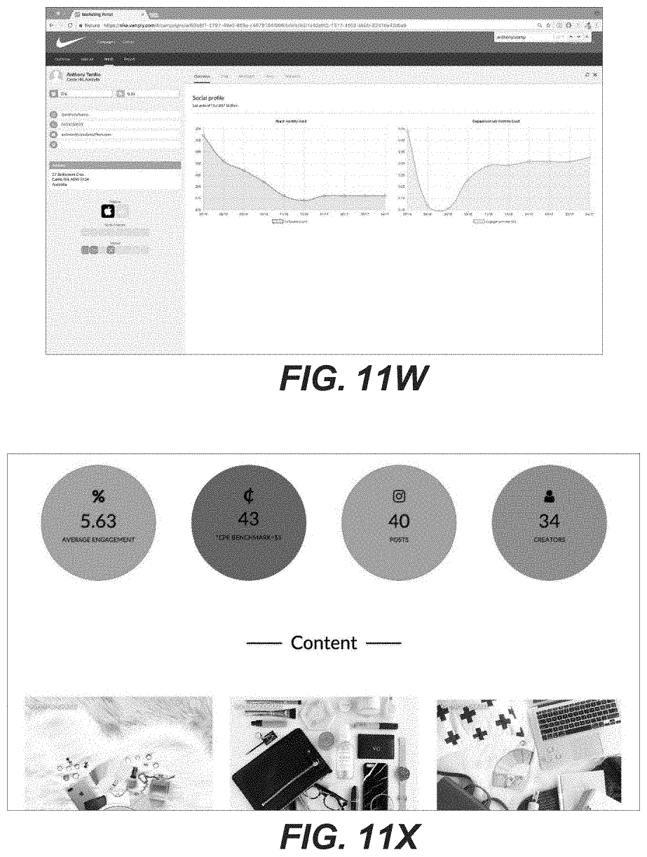

Referring to FIGS. 11A to 11X, there is illustrated screenshots of an embodiment of the system for use with a personal computer or desktop display, for example. The screenshots are representations and may relate to the method and process intervals of the representations of FIGS. 2 to 10.

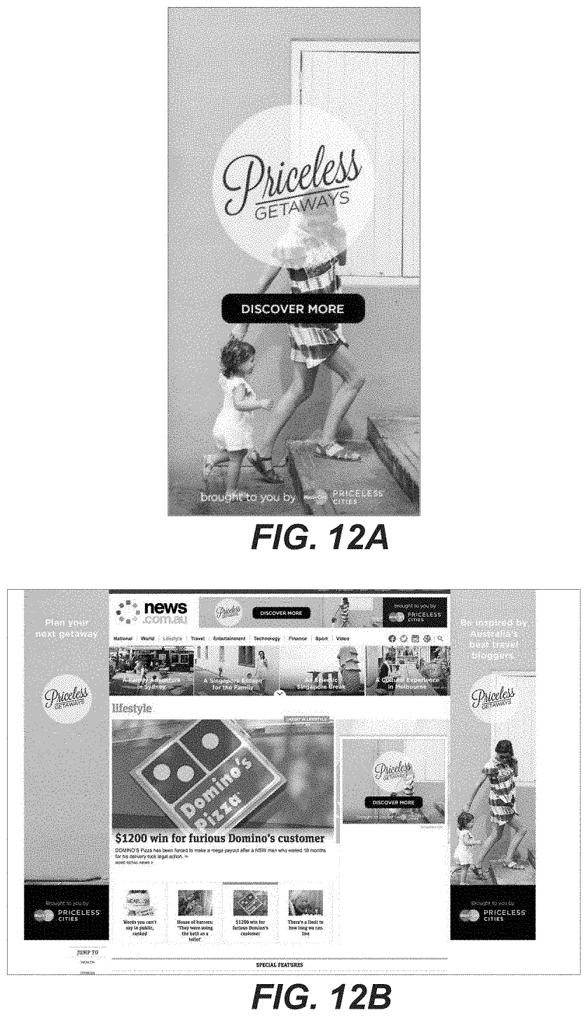

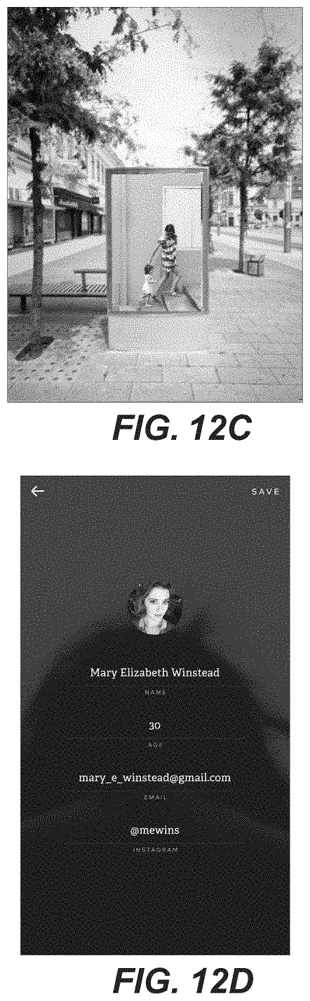

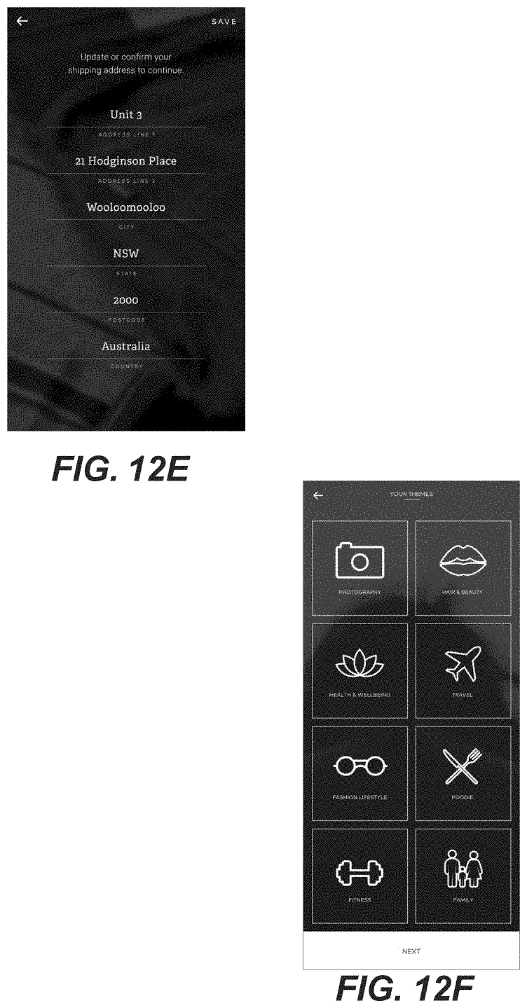

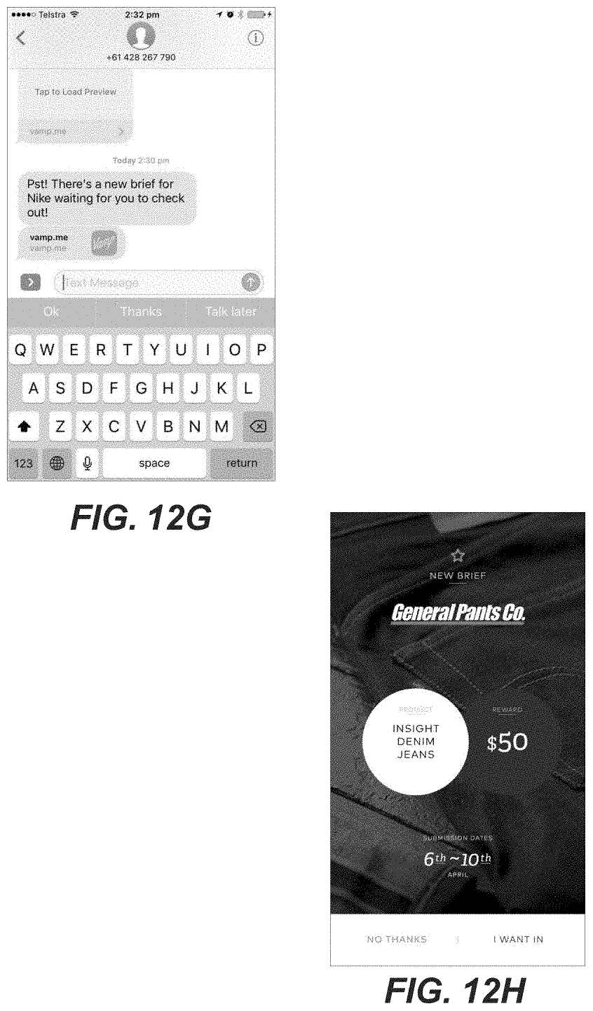

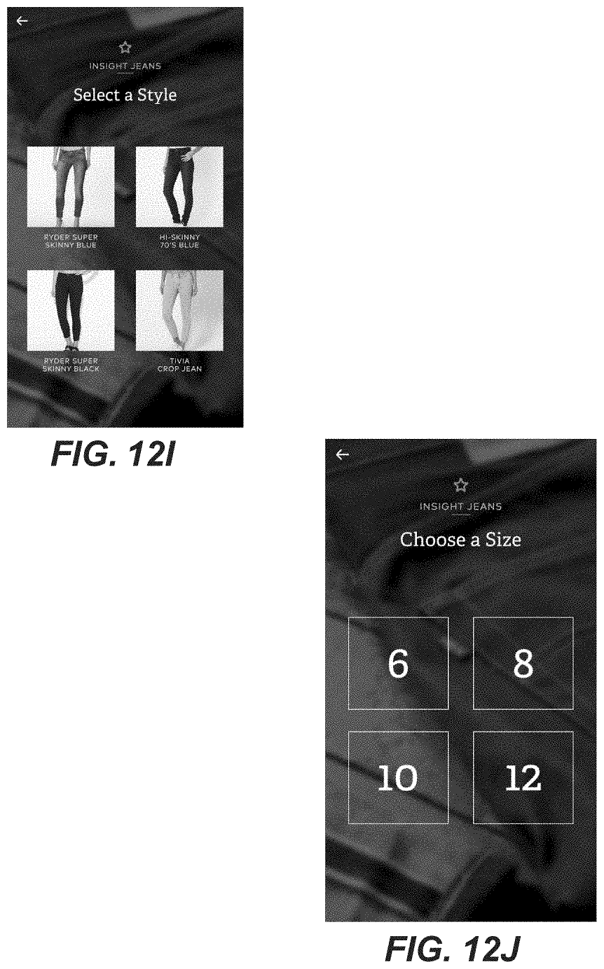

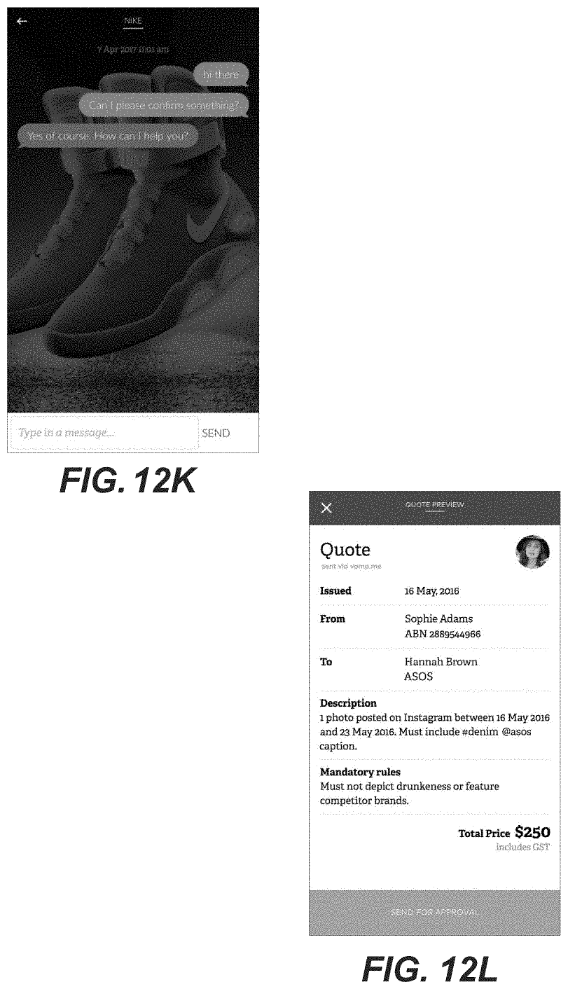

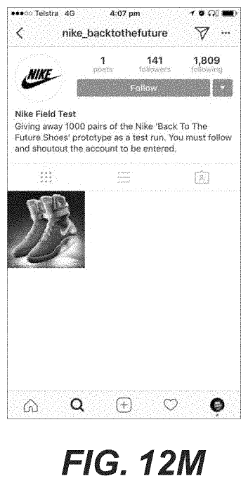

Referring to FIGS. 12A to 12M, there is illustrated screenshots of an embodiment of the system for use with a mobile or handheld device, for example. The screenshots are representations and may relate to the method and process intervals of the representations of FIGS. 2 to 10.

Although the disclosure has been described with reference to specific examples, it will be appreciated by those skilled in the art that the disclosure may be embodied in many other forms, in keeping with the broad principles and the spirit of the invention described herein.

What is claimed is:

1. A method for use on a computing device connected to the Internet for social media distribution, wherein the method comprises the steps of:
registering a campaign with at least one data set related to at least one of: an age, a gender, a sex, a theme, a demographic, a jurisdiction, a location and a desired engagement rate, wherein the campaign being related to a social market media campaign with a predefined online handle or metadata set;
from a user terminal connecting accessing a database management system for compiling a set of online identities of social media users on social media websites matching one or data sets related to the campaign;
sending at least one message including social media content associated with the online handle or metadata set to a social media user, and
wherein the social media user can accept to distribute social media with the online handle or metadata set from at least one private account.

2. The method of claim 1, wherein the step of compiling a set of online identities further comprises the steps of adding one or more online identities to the database management system.

3. The method of claim 1, wherein the step of compiling a set of online identities further comprises filtering one or more online identities from the set.

4. The method of claim 1, further comprising the steps of:
displaying one or more statistical reports in accordance with the retrieved set of online identities;
receiving input from a user terminal to adjust the statistical data on the statistical presentations; and
adding or removing one or more online identities such that the set of online identities satisfies the adjusted statistical data.

5. The method of claim 1, wherein the campaign is assigned a predetermined period of time for distribution of social media via at least one private account.

6. The method of claim 1, further comprising the step of sending an electronic invitation in one data format to each of the online identities in the set.

7. The method of claim 1, wherein the social media user is an Influencer with a minimum number of followers or average daily viewers.

8. The method of claim 1, wherein the at least one message comprises a commission or offer for posting on social media via a private account.

9. The method of claim 1, further comprising the steps of: compiling a tracking report in accordance with the retrieved social media content, wherein the tracking report comprising a list of each online identities and corresponding status in the marketing campaign.

10. The method of claim 9, wherein the campaign creator can edit, delete or hide at least one social media distribution associated with the online handle or metadata set from at least one private account.

11. The method of claim 1, further comprising the steps of:
confirming a task completion such that a predetermined payment is made to a social media user account associated with the at least one private account; and
updating the status of the campaign.

12. The method of claim 11, further comprising the step of making an electronic payment to the online identity based on the payment threshold status through a transaction server.

13. The method of claim 1, further comprising the step of determining the number of social media users desirable for a campaign and the number of social media distributions with the online handle or metadata set.

14. The method of claim 1, further comprising the steps of automatically distributing, linking, or sharing one or more retrieved social media contents on a webpage.

15. A computer system, having a processing unit, data management system, and a communication module for connecting to the Internet, comprising:
a user interface adapted to receiving at least one data set from a first user of the system, the at least one dataset being related to a social media campaign;
wherein the at least one dataset comprises data related to at least one of: age, gender, theme, number of follows, engagement rate, related to a social market media campaign with a predefined online handle or a predefined metadata tag to the computer server;
wherein the database management system is adapted to allow the first user searching and compiling data from the database management system related to the social media campaign, and the compiled data including a list of social media websites matching one or more datasets of the campaign;
a data retriever adapted to retrieving social media content from one or more social media websites associated with the online handle and a user of the social media websites; and
the processing unit being adapted to calculate the value of a social media user in relation to a campaign based on at least one of a follower count, a viewer count, a social media presence, a trending threshold, and a public opinion of the social media user.

16. A computer system of claim 15, wherein the processing unit is adapted to determine a payment threshold for a predetermined number of social media posts by the social media user, and forwarding electronic payment instructions to a transaction server for transferring payment to the online identity.

17. The computer system of claim 15, wherein the processing unit can automatically distribute, link, and/or share one or more social media posts on a remote web server.

18. The computer system of claim 15, wherein the interface is adapted to allow the social media user distributing at least one social media post via the system that can be edited, hidden, or deleted by the first user of the system when the social media post includes the predefined online handle or the predefined metadata tag.

19. The computer system of claim 15, wherein the communication module is adapted to send at least one message to the social media user of the system including a request, a personal message, an update, a quote, or an order.

20. The computer system of claim 16, wherein social media posts made via the system by the social media user are remunerated at a predetermined rate in accordance with the campaign.
